(19) United States
(12) Patent Application Publication
(10) Pub. No.: US 2012/0182966 A1
(43) Pub. Date: Jul. 19, 2012

(54) OUT-OF-BAND PAGING FOR PROXIMITY DETECTION IN A FEMTO DEPLOYMENT

(75) Inventors: Soumya Das, San Diego, CA (US); Samir S. Soliman, San Diego, CA (US)

(73) Assignee: QUALCOMM Incorporated, San Diego, CA (US)

(21) Appl. No.: 13/008,277

(22) Filed: Jan. 18, 2011

(51) Int. Cl. H04W 4/20; H04W 36/08

(52) U.S. Cl. 370/331; 370/328

(57) ABSTRACT

Systems, methods, devices, and computer program products are described for using an out-of-band (OOB) radio integrated with the femtocell to implement various novel proximity detection techniques. Proximity detection of access terminals (ATs) in the femtocell's access control list (ACL) may be desirable to support femto connectivity and service provision, for example, in context of idle macro-to-femto handoffs, active macro-to-femto hand-ins, etc. When multiple ATs are in the ACL, and particularly when the ATs have different OOB implementations, optimizing proximity detection may involve balancing reliability against latency. Embodiments implement OOB proximity detection according to techniques that address reliability, efficiency, and/or fairness of proximity detection, even across unmanaged OOB networks and for ATs having different OOB implementations.

### BACKGROUND

Information communication provided by various forms of networks is in wide use in the world today. Networks having multiple nodes in communication using wireless and wireline links are used, for example, to carry voice and/or data. The nodes of such networks may be computers, personal digital assistants (PDAs), phones, servers, routers, switches, multiplexers, modems, radios, access points, base stations, etc. Many client device nodes (also referred to as user equipment (UE) or access terminals (ATs)), such as cellular phones, PDAs, laptop computers, etc., are mobile and thus may connect with a network through a number of different interfaces.

Mobile client devices may connect with a network wirelessly via a base station, access point, wireless router, etc. (collectively referred to herein as access points). A mobile client device may remain within the service area of such an access point for a relatively long period of time (referred to as being “camped on” the access point), or may travel relatively rapidly through access point service areas, with cellular handoff or reselection techniques being used for maintaining a communication session or for idle mode operation as association with access points is changed.

Issues with respect to available spectrum, bandwidth, capacity, etc. may result in a network interface being unavailable or inadequate between a particular client device and access point. Moreover, issues with respect to wireless signal propagation, such as shadowing, multipath fading, interference, etc., may result in a network interface being unavailable or inadequate between a particular client device and access point.

Cellular networks have employed the use of various cell types, such as macrocells, microcells, picocells, and femtocells, to provide desired bandwidth, capacity, and wireless communication coverage within service areas. For example, the use of femtocells is often desirable to provide wireless communication in areas of poor network coverage (e.g., inside of buildings), to provide increased network capacity, to utilize broadband network capacity for backhaul, etc.

### SUMMARY

The present disclosure is directed to systems and methods for using an out-of-band (OOB) radio integrated with a femtocell for detection of access terminals (ATs) in the femtocell's proximity. Multiple ATs may be authorized to communicate with a femtocell according to an access control list maintained by the femtocell, and it may be desirable for the femtocell to continually or periodically detect proximity of those authorized ATs to support communications with them as appropriate (e.g., to facilitate idle macro-to-femto handoffs, active macro-to-femto hand-ins, etc.). Embodiments use an OOB radio integrated with the femtocell to implement various novel proximity detection techniques that are reliable, efficient, and/or fair across ATs having different OOB implementations.

For example, some techniques use the OOB radio to communicate proximity request messages to ATs according to a round-robin scheme. According to some such techniques, an interval at which the proximity request message is sent is different for those ATs in proximity to the femtocell and those not in proximity to the femtocell. Other techniques associate each AT with a detection timeout (e.g., based on a model and make of the AT, and/or some other non-dynamic characteristic of the AT, and/or dynamically adjusted based on a monitored response time of the AT), and the round-robin scheme is determined according to the detection timeout. Still other techniques associate each AT with a paging interval, and the round-robin scheme is determined according to the paging intervals. According to some such techniques, the paging interval for an AT is determined according to the detection timeout associated with the AT, for example, so that substantially the same detection time is spent for each AT (e.g., ATs having a shorter timeout are detected more frequently).

An exemplary method for out-of-band paging in a femto deployment includes: communicating proximity request messages over an OOB communications channel using an out-of-band (OOB) radio to each of a plurality of access terminals according to a round-robin scheme; and receiving a proximity response message from at least one access terminal over the OOB communications channel using the OOB radio, the proximity response message indicating that the at least one access terminal is in proximity to a femtocell, the femtocell being integrated with the OOB radio as part of a femto-proxy system and the plurality of access terminals being authorized to communicate via the femtocell according to an access control list associated with the femtocell. Some such methods further include establishing a wireless wide area network (WWAN) link between the at least one access terminal and the femtocell in response to receiving the proximity response message from the at least one access terminal when the at least one access terminal is in an active communications mode.

Also or alternatively, the plurality of access terminals includes a first subset of access terminals in proximity to the femtocell and a second subset of access terminals not in proximity to the femtocell, the first subset of access terminals comprising the at least one access terminal; and communicating the proximity request messages over the OOB communications channel using the OOB radio to each of the plurality of access terminals according to the round-robin scheme includes: communicating the proximity request messages over the OOB communications channel using the OOB radio to each of the first subset of access terminals according to a first time interval; and communicating the proximity request messages over the OOB communications channel using the OOB radio to each of the second subset of access terminals according to a second time interval. For example, the first time interval is longer than the second time interval.

Some such methods further include determining the round-robin scheme at least partially according to detection timeouts associated with each of the plurality of access terminals, each detection timeout corresponding to an amount of time to wait for receipt of a proximity response message from its associated access terminal after communicating a corresponding proximity request message to its associated access terminal. Some may further include determining at least one detection timeout at least according to a non-dynamic characteristic of its associated access terminal. Others may further include: detecting a non-dynamic characteristic of a designated access terminal from information received from the designated access terminal over the OOB communications channel; retrieving a preset value from a data store corresponding to the non-dynamic characteristic of the designated access terminal; and setting the detection timeout associated with the designated access terminal according to the preset value. Still others may further include: for a designated access terminal of the first subset of access terminals, monitoring an elapsed time between communicating a proximity request message to the designated access terminal and receiving a corresponding proximity response message from the designated access terminal; and dynamically adjusting the detection timeout associated with the designated access terminal according to the monitored elapsed time.

Even others may further include: determining the round-robin scheme further according to paging intervals associated with each of the plurality of access terminals, each paging interval corresponding to an amount of time to wait between communicating a proximity request message to its associated access terminal and communicating a next proximity request message to its associated access terminal. In some such cases, the method further includes determining each paging interval according to the detection timeout of its associated access terminal, such that longer paging intervals are associated with access terminals having longer detection timeouts. In other such cases, the method further includes determining each paging interval according to the detection timeout of its associated access terminal, such that each access terminal is associated with substantially a same average detection time, the average detection time over a duration for each access terminal being defined by dividing the duration by the paging interval of the access terminal to yield a result, and multiplying the result by the detection timeout of the access terminal.

In some such methods, the OOB communications channel is an ad hoc communications channel. The OOB communications channel may be a Bluetooth channel; and the proximity request messages may be Bluetooth paging messages.

In some such methods, the method further includes: identifying an attached access terminal as having an established OOB communications link over the OOB communications channel with the OOB radio; communicating the proximity request messages to the attached access terminal over the OOB link without including the attached access terminal in the round-robin scheme; and receiving the proximity response message from the attached access terminal over the OOB communications link. For example, the OOB communications link is a Bluetooth link; and the proximity request messages are Bluetooth polling messages.

An exemplary femto-proxy system includes: a femtocell, configured to provide macro network access to a plurality of access terminals authorized to attach to the femtocell according to an access control list; and an out-of-band (OOB) radio, integrated with the femtocell and configured to: communicate a proximity request message over an OOB communications channel to each of the plurality of access terminals according to a round-robin scheme; and receive a proximity response message over the OOB communications channel from at least one access terminal, the proximity response message indicating that the at least one access terminal is in proximity to the femtocell. In some such systems, the femtocell is further configured to establish a wireless wide area network (WWAN) link with the at least one access terminal in response to the OOB radio receiving the proximity response message from the at least one access terminal when the at least one access terminal is in an active communications mode.

An exemplary processor includes: a femto controller configured to direct a femtocell to provide macro network access to a plurality of access terminals authorized to attach to the femtocell according to an access control list; and an out-of-band (OOB) controller configured to direct an OOB radio to: communicate a proximity request message over an OOB communications channel to each of the plurality of access terminals according to a round-robin scheme; and receive a proximity response message over the OOB communications channel from at least one access terminal, the proximity response message indicating that the at least one access terminal is in proximity to the femtocell. In some such processors, the femto controller is further configured to establish a wireless wide area network (WWAN) link between the at least one access terminal and the femtocell in response to the OOB controller receiving the proximity response message from the at least one access terminal when the at least one access terminal is in an active communications mode.

An exemplary computer program product resides on a processor-readable medium and has processor-readable instructions, which, when executed, cause a processor to perform steps including: communicating proximity request messages over an OOB communications channel using an out-of-band (OOB) radio to each of a plurality of access terminals according to a round-robin scheme; and receiving a proximity response message from at least one access terminal over the OOB communications channel using the OOB radio, the proximity response message indicating that the at least one access terminal is in proximity to a femtocell, the femtocell being integrated with the OOB radio as part of a femto-proxy system and the plurality of access terminals being authorized to communicate via the femtocell according to an access control list associated with the femtocell. Some such processor-readable instructions, when executed, cause the processor to perform steps further including establishing a wireless wide area network (WWAN) link between the at least one access terminal and the femtocell in response to receiving the proximity response message from the at least one access terminal when the at least one access terminal is in an active communications mode.

Another exemplary system includes: means for communicating proximity request messages over an OOB communications channel using an out-of-band (OOB) radio to each of a plurality of access terminals according to a round-robin scheme; and means for receiving a proximity response message from at least one access terminal over the OOB communications channel using the OOB radio, the proximity response message indicating that the at least one access terminal is in proximity to a femtocell, the femtocell being integrated with the OOB radio as part of a femto-proxy system and the plurality of access terminals being authorized to communicate via the femtocell according to an access control list associated with the femtocell. Some such systems further include means for establishing a wireless wide area network (WWAN) link between the at least one access terminal and the femtocell in response to receiving the proximity response message from the at least one access terminal when the at least one access terminal is in an active communications mode.

The foregoing has outlined rather broadly the features and technical advantages of examples according to disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages, will be better understood from the following description when considered in connection with the accompanying figures. Each of the figures is provided for the purpose of illustration and description only and not as a definition of the limits of the claims.

### BRIEF DESCRIPTION OF THE DRAWINGS

A further understanding of the nature and advantages of examples provided by the disclosure may be realized by reference to the remaining portions of the specification and the drawings, wherein like reference numerals are used throughout the several drawings to refer to similar components. In some instances, a sub-label is associated with a reference numeral to denote one of multiple similar components. When reference is made to a reference numeral without specification to an existing sub-label, the reference numeral refers to all such similar components.

FIG. 1 shows a block diagram of a wireless communications system;

FIG. 2A shows a block diagram of an exemplary wireless communications system that includes a femto-proxy system;

FIG. 2B shows a block diagram of an exemplary wireless communications system that includes an architecture of a femto-proxy system that is different from the architecture shown in FIG. 2A;

FIG. 3 shows a block diagram of an example of a processor module for implementing functionality of a communications management subsystem shown in FIG. 2A;

FIG. 4A shows detail regarding an example of a femtocell architecture for legacy circuit services, for example, for CDMA 1x networks;

FIG. 4B shows detail regarding an example of a femtocell architecture for packet data service access using legacy interfaces, for example, for HRPD networks;

FIG. 5 shows a block diagram of an example of a mobile access terminal for use with the femto-proxy systems of FIGS. 2A and 2B in the context of the communications systems and networks of FIGS. 1-4B;

FIG. 6 shows a simplified network environment illustrating an exemplary scenario in which multiple ATs are in different locations and communication states with respect to a femto-proxy system;

FIG. 7A shows a simplified signaling diagram in which a round-robin scheme is used for proximity detection over an OOB channel;

FIG. 7B shows a simplified signaling diagram illustrating a modification to the round-robin scheme in which paging intervals are adjusted according to proximity of the ATs;

FIG. 7C shows a simplified signaling diagram illustrating a modification to the round-robin scheme in which detection timeouts are adjusted according to characteristics of each AT;

FIGS. 7D and 7E show simplified signaling diagrams illustrating modifications to the round-robin scheme in which detection timeouts and paging intervals are adjusted according to each AT's OOB implementation to spend substantially equal time detecting each AT;

FIG. 8 shows a flow diagram of an exemplary method for OOB proximity detection in a femto deployment;

FIG. 9A shows a flow diagram of an exemplary method for varying the method of FIG. 8 to change paging intervals according to proximity of ATs;

FIG. 9B shows a flow diagram of an exemplary method for varying the method of FIG. 8 to use polling over an OOB link according to proximity of ATs;

FIG. 10A shows a flow diagram of an exemplary method for implementing OOB proximity detection using adjusted detection timeouts;

FIG. 10B shows a flow diagram of an exemplary method for determining an appropriate detection timeout for each AT;

FIG. 10C shows a flow diagram of another exemplary method for determining an appropriate detection timeout for each AT; and

FIG. 11 shows a flow diagram of such an exemplary method for OOB proximity detection that includes determining and adjusting both the paging intervals and the detection timeouts for each AT.

### DETAILED DESCRIPTION

Typically, multiple ATs are authorized to communicate with a femtocell according to an access control list maintained by the femtocell. In order to maintain communications links with those ATs as appropriate (e.g., to facilitate idle macro-to-femto handoffs, active macro-to-femto hand-ins, etc.), the femtocell determines when an authorized AT enters or leaves a coverage area associated with the femtocell by monitoring each AT's proximity to the femtocell. Using WWAN (e.g., cellular) techniques to monitor proximity may be undesirable, for example, as configuring the AT to periodically send registration messages to the femtocell may undesirably impact battery life of the AT.

Accordingly, systems and methods are described for using an OOB radio integrated with the femtocell to implement various novel proximity detection techniques. Typically, various authorized ATs are configured with different OOB implementations (e.g., different implementations of an OOB protocol stack), such that detection of all ATs in precisely the same manner may favor some implementations over others. This may not cause issues for femto detection over the WWAN link, for example, as the WWAN link may be established according to a managed network protocol, whereby timing and other parameters are negotiated with each AT. Communications over the OOB channel, however, may be implemented according to an unmanaged (e.g., ad hoc, peer-to-peer) protocol, such that timing parameters are not negotiated. Various techniques described herein implement reliable, efficient, and/or fair proximity detection over an OOB channel, even across an unmanaged OOB network and for ATs having different OOB implementations.

Techniques described herein for OOB detection of mobiles at femtocells may be used for femtocells using various wireless communication systems such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above, as well as for other systems and radio technologies.

Thus, the following description provides examples and is not limiting of the scope, applicability, or configuration set forth in the claims. Changes may be made in the function and arrangement of elements discussed without departing from the spirit and scope of the disclosure. Various examples may omit, substitute, or add various procedures or components as appropriate. For instance, the methods described may be performed in an order different from that described, and various operations may be added, omitted, or combined. Also, features described with respect to certain examples may be combined in other examples.

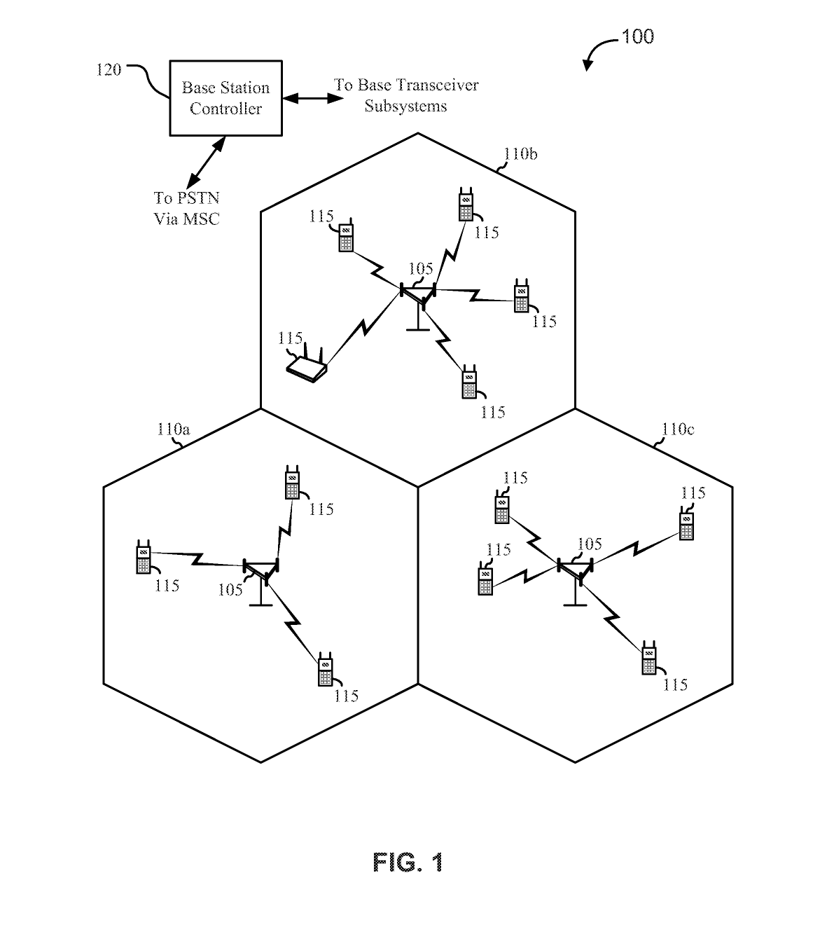

Referring first to FIG. 1, a block diagram illustrates an example of a wireless communications system 100. The system 100 includes base transceiver stations (BTSs) 105, disposed in cells 110, mobile access terminals 115 (ATs), and a base station controller (BSC) 120. It is worth noting that terminology like access terminal (AT), mobile station (MS), and others are used interchangeably herein and are not intended to imply a particular network topology or implementation. For example, while the “MS” terminology may typically be used for circuit switched (e.g., CDMA 1X) networks, and the “AT” terminology may typically be used for packet data service (e.g., EV-DO, HRPD) networks, the techniques described herein may be applied in the context of any of these or other networks.

The system 100 may support operation on multiple carriers (e.g., waveform signals of different frequencies). Multi-carrier transmitters can transmit modulated signals simultaneously on the multiple carriers. Each modulated signal may be a CDMA signal, a TDMA signal, an OFDMA signal, a SC-FDMA signal, etc. Each modulated signal may be sent on a different carrier and may carry pilot, overhead information, data, etc. The system 100 may be a multi-carrier LTE network capable of efficiently allocating network resources.

The BTSs 105 can wirelessly communicate with the ATs 115 via a base station antenna. The BTSs 105 are configured to communicate with the ATs 115 under the control of the BSC 120 via multiple carriers. Each of the BTSs 105 can provide communication coverage for a respective geographic area, indicated here by cells 110-a, 110-b, or 110-c. The system 100 may include BTSs 105 of different types, for example, macro, pico, and/or femto base stations.

The ATs 115 can be dispersed throughout the cells 110. The ATs 115 may be referred to as mobile stations, mobile devices, user equipment (UE), or subscriber units. The ATs 115 here include cellular phones and a wireless communication device, but can also include personal digital assistants (PDAs), other handheld devices, netbooks, notebook computers, etc.

For the discussion below, the ATs 115 operate on (are “camped” on) a macro or similar network facilitated by multiple “macro” BTSs 105. Each macro BTS 105 may cover a relatively large geographic area (e.g., several kilometers in radius) and may allow unrestricted access by terminals with service subscription. The ATs 115 are also registered to operate on at least one femto network facilitated by a “femto” or “home” BTS 105. It will be appreciated that, while the macro BTSs 105 may typically be deployed according to network planning (e.g., resulting in the illustrative hexagonal cells 110 shown in FIG. 1), a femto BTS 105 may typically be deployed by individual users (or user representatives) to create a localized femtocell. The localized femtocell does not typically follow the macro network planning architecture (e.g., the hexagonal cells), although it may be accounted for as part of various macro-level network planning and/or management decisions (e.g., load balancing, etc.).

The AT 115 may generally operate using an internal power supply, such as a small battery, to facilitate highly mobile operations. Strategic deployment of network devices, such as femtocells, can mitigate mobile device power consumption to some extent. For example, femtocells may be utilized to provide service within areas which might not otherwise experience adequate or even any service (e.g., due to capacity limitations, bandwidth limitations, signal fading, signal shadowing, etc.), thereby allowing client devices to reduce searching times, to reduce transmit power, to reduce transmit times, etc. Femtocells provide service within a relatively small service area (e.g., within a house or building). Accordingly, a client device is typically disposed near a femtocell when being served, often allowing the client device to communicate with reduced transmission power.

For example, the femto cell is implemented as a femto access point (FAP) located in a user premises, such as a residence, an office building, etc. The location may be chosen for maximum coverage (e.g., in a centralized location), to allow access to a global positioning satellite (GPS) signal (e.g., near a window), and/or in any other useful location. For the sake of clarity, the disclosure herein assumes that a set of ATs 115 are registered for (e.g., on a whitelist of) a single FAP that provides coverage over substantially an entire user premises. The “home” FAP provides the ATs 115 with access to communication services over the macro network. As used herein, the macro network is assumed to be a wireless wide-area network (WWAN). As such, terms like “macro network” and “WWAN network” are interchangeable. Similar techniques may be applied to other types of network environments without departing from the scope of the disclosure or claims.

In example configurations, the FAP is integrated with one or more out-of-band (OOB) proxies as a femto-proxy system. As used herein, “out-of-band” or “OOB” includes any type of communications that are out of band with respect to the WWAN link. For example, the OOB proxies and/or the ATs 115 may be configured to operate using Bluetooth (e.g., class 1, class 1.5, and/or class 2), ZigBee (e.g., according to the IEEE 802.15.4-2003 wireless standard), WiFi, and/or any other useful type of communications out of the macro network band. Notably, OOB integration with the FAP may provide a number of features, including, for example, reduced interference, lower power femto discovery, etc.

Further, the integration of OOB functionality with the FAP may allow the ATs 115 attached to the FAP to also be part of an OOB piconet. The piconet may facilitate enhanced FAP functionality, other communications services, power management functionality, and/or other features to the ATs 115. These and other features will be further appreciated from the description below.

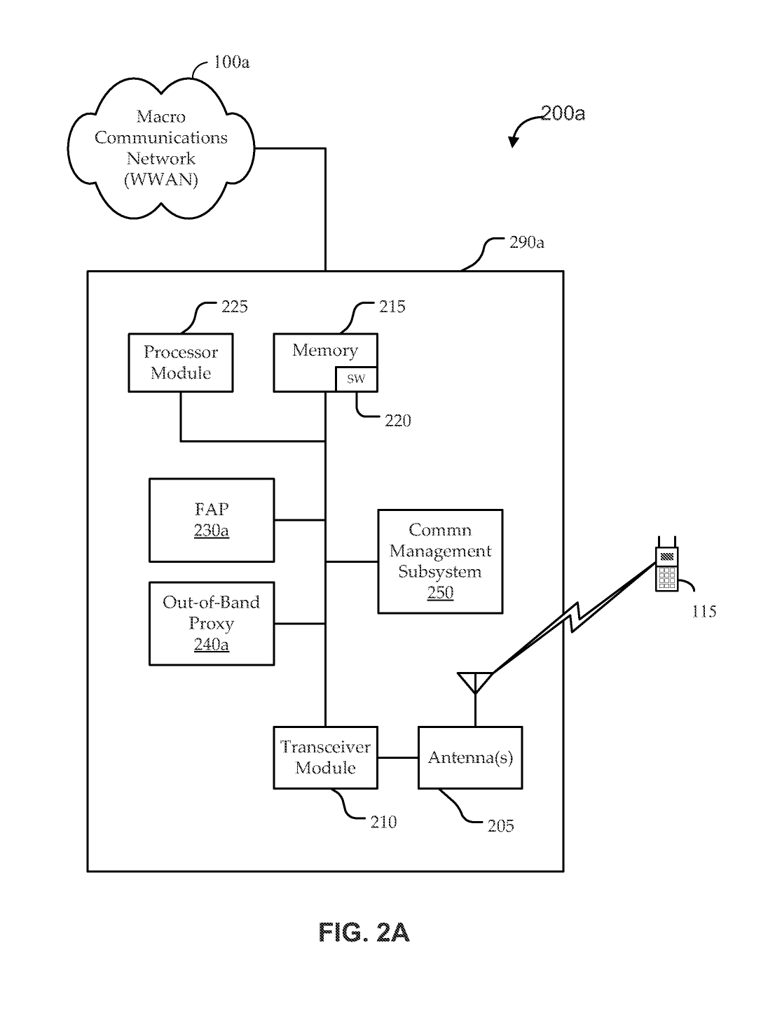

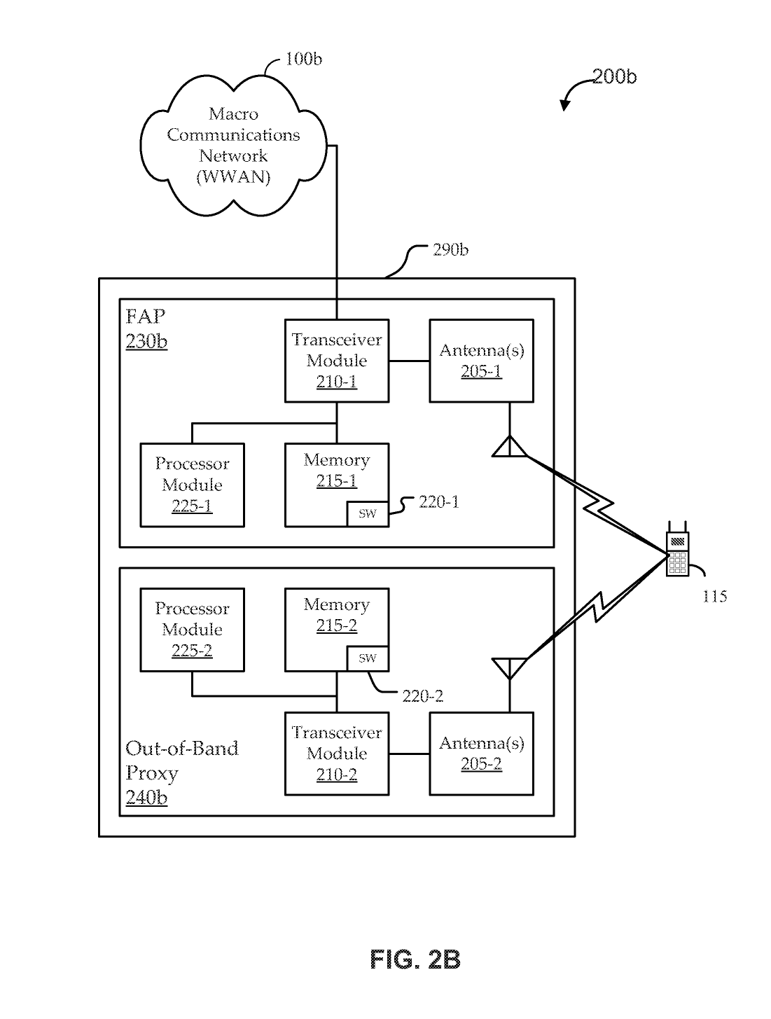

FIG. 2A shows a block diagram of a wireless communications system 200a that includes a femto-proxy system 290a. The femto-proxy system 290a includes an OOB proxy 240a, a FAP 230a, and a communications management subsystem 250. The FAP 230a may be a femto BTS 105, as described with reference to FIG. 1. The femto-proxy system 290a also includes antennas 205, a transceiver module 210, memory 215, and a processor module 225, which each may be in communication, directly or indirectly, with each other (e.g., over one or more buses). The transceiver module 210 is configured to communicate bi-directionally, via the antennas 205, with the ATs 115. The transceiver module 210 (and/or other components of the femto-proxy system 290a) is also configured to communicate bi-directionally with a macro communications network 100a (e.g., a WWAN). For example, the transceiver module 210 is configured to communicate with the macro communications network 100a via a backhaul network. The macro communications network 100a may be the communications system 100 of FIG. 1.

The memory 215 may include random access memory (RAM) and read-only memory (ROM). The memory 215 may also store computer-readable, computer-executable software code 220 containing instructions that are configured, when executed, to cause the processor module 225 to perform various functions described herein (e.g., call processing, database management, message routing, etc.). Alternatively, the software 220 may not be directly executable by the processor module 225, but may be configured to cause the computer, when compiled and executed, to perform functions described herein.

The processor module 225 may include an intelligent hardware device, for example, a central processing unit (CPU) such as those made by Intel® Corporation or AMD®, a microcontroller, an application specific integrated circuit (ASIC), etc. The processor module 225 may include a speech encoder (not shown) configured to receive audio via a microphone, convert the audio into packets (e.g., 30 ms in length) representative of the received audio, provide the audio packets to the transceiver module 210, and provide indications of whether a user is speaking Alternatively, an encoder may only provide packets to the transceiver module 210, with the provision or withholding/suppression of the packet itself providing the indication of whether a user is speaking

The transceiver module 210 may include a modem configured to modulate the packets and provide the modulated packets to the antennas 205 for transmission, and to demodulate packets received from the antennas 205. While some examples of the femto-proxy system 290a may include a single antenna 205, the femto-proxy system 290a preferably includes multiple antennas 205 for multiple links or channels. For example, one or more links or channels may be used to support macro communications with the ATs 115. Also, one or more out-of-band links or channels may be supported by the same antenna 205 or different antennas 205.

Notably, the femto-proxy system 290a is configured to provide both FAP 230a and OOB proxy 240a functionality. For example, when the AT 115 approaches the femtocell coverage area, the AT's 115 OOB radio may begin searching for the OOB proxy 240a. Various novel techniques for AT 115 discovery using the OOB radio are described in more detail below. Upon discovery, the AT 115 may have a high level of confidence that it is in proximity to the femtocell coverage area, and a scan for the FAP 230a can commence.

The scan for the FAP 230a may be implemented in different ways. For example, due to the OOB proxy 240a discovery by the AT's 115 OOB radio, both the AT 115 and the femto-proxy system 290a may be aware of each other's proximity. The AT 115 scans for the FAP 230a. Alternatively, the FAP 230a polls for the AT 115 (e.g., individually or as part of a round-robin polling of all registered ATs 115), and the AT 115 listens for the poll. When the scan for the FAP 230a is successful, the AT 115 may attach to the FAP 230a.

When the AT 115 is in the femtocell coverage area and attached to the FAP 230a, the AT 115 may be in communication with the macro communications network 100a via the FAP 230a. As described above, the AT 115 may also be a slave of a piconet for which the OOB proxy 240a acts as the master. For example, the piconet may operate using Bluetooth and may include Bluetooth communications links facilitated by a Bluetooth radio (e.g., implemented as part of the transceiver module 210) in the FAP 230a.

Examples of the FAP 230a have various configurations of base station or wireless access point equipment. As used herein, the FAP 230a may be a device that communicates with various terminals (e.g., client devices (ATs 115, etc.), proximity agent devices, etc.) and may also be referred to as, and include some or all the functionality of, a base station, a Node B, and/or other similar devices. Although referred to herein as the FAP 230a, the concepts herein are applicable to access point configurations other than femtocell configuration (e.g., picocells, microcells, etc.). Examples of the FAP 230a utilize communication frequencies and protocols native to a corresponding cellular network (e.g., the macro communications network 100a, or a portion thereof) to facilitate communication within a femtocell coverage area associated with the FAP 230a (e.g., to provide improved coverage of an area, to provide increased capacity, to provide increased bandwidth, etc.).

The FAP 230a may be in communication with other interfaces not explicitly shown in FIG. 2A. For example, the FAP 230a may be in communication with a native cellular interface as part of the transceiver module 210 (e.g., a specialized transceiver utilizing cellular network communication techniques that may consume relatively large amounts of power in operation) for communicating with various appropriately configured devices, such as the AT 115, through a native cellular wireless link (e.g., an “in band” communication link). Such a communication interface may operate according to various communication standards, including but not limited to wideband code division multiple access (W-CDMA), CDMA2000, global system for mobile telecommunication (GSM), worldwide interoperability for microwave access (WiMax), and wireless LAN (WLAN). Also or alternatively, the FAP 230a may be in communication with one or more backend network interfaces as part of the transceiver module 210 (e.g., a backhaul interface providing communication via the Internet, a packet switched network, a switched network, a radio network, a control network, a wired link, and/or the like) for communicating with various devices or other networks.

As described above, the FAP 230a may further be in communication with one or more OOB interfaces as part of the transceiver module 210 and/or the OOB proxy 240a. For example, the OOB interfaces may include transceivers that consume relatively low amounts of power in operation and/or may cause less interference in the in-band spectrum with respect to the in-band transceivers. Such an OOB interface may be utilized according to embodiments to provide low power wireless communications with respect to various appropriately configured devices, such as an OOB radio of the AT 115. The OOB interface may, for example, provide a Bluetooth link, an ultra-wideband (UWB) link, an IEEE 802.11 (WLAN) link, etc.

The terms “high power” and “low power” as used herein are relative terms and do not imply a particular level of power consumption. Accordingly, OOB devices (e.g., OOB proxy 240a) may simply consume less power than native cellular interface (e.g., for macro WWAN communications) for a given time of operation. In some implementations, OOB interfaces also provide relatively lower bandwidth communications, relatively shorter range communication, and/or consume relatively lower power in comparison to the macro communications interfaces. There is no limitation that the OOB devices and interfaces be low power, short range, and/or low bandwidth. Devices may use any suitable out-of-band link or channel, whether wireless or otherwise, such as IEEE 802.11, Bluetooth, PEANUT, UWB, ZigBee, a wired link, etc.

OOB proxies 240a may provide various types of OOB functionality and may be implemented in various ways. An OOB proxy 240a may have any of various configurations, such as a stand-alone processor-based system, a processor-based system integrated with a host device (e.g., access point, gateway, router, switch, repeater, hub, concentrator, etc.), etc. For example, the OOB proxies 240a may include various types of interfaces for facilitating various types of communications.

Some OOB proxies 240a include one or more OOB interfaces as part of the transceiver module 210 (e.g., a transceiver that may consume relatively low amounts of power in operation and/or may cause less interference than in the in-band spectrum) for communicating with other appropriately configured devices (e.g., an AT 115) for providing interference mitigation and/or femtocell selection herein through a wireless link. One example of a suitable communication interface is a Bluetooth-compliant transceiver that uses a time-division duplex (TDD) scheme.

OOB proxies 240a may also include one or more backend network interfaces as part of the transceiver module 210 (e.g., packet switched network interface, switched network interface, radio network interface, control network interface, a wired link, and/or the like) for communicating with various devices or networks. An OOB proxy 240a that is integrated within a host device, such as with FAP 230a, may utilize an internal bus or other such communication interface in the alternative to a backend network interface to provide communications between the OOB proxy 240a and other devices, if desired. Additionally or alternatively, other interfaces, such as OOB interfaces, native cellular interfaces, etc., may be utilized to provide communication between the OOB proxy 240a and the FAP 230a and/or other devices or networks.

Various communications functions (e.g., including those of the FAP 230a and/or the OOB proxy 240a) may be managed using the communications management subsystem 250. For example, the communications management subsystem 250 may at least partially handle communications with the macro (e.g., WWAN) network, one or more OOB networks (e.g., piconets, AT 115 OOB radios, other femto-proxies, OOB beacons, etc.), one or more other femtocells (e.g., FAPs 230), ATs 115, etc. For example, the communications management subsystem 250 may be a component of the femto-proxy system 290a in communication with some or all of the other components of the femto-proxy system 290a via a bus.

Various other architectures are possible other than those illustrated by FIG. 2A. The FAP 230a and OOB proxy 240a may or may not be collocated, integrated into a single device, configured to share components, etc. For example, the femto-proxy system 290a of FIG. 2A has an integrated FAP 230a and OOB proxy 240a that at least partially share components, including the antennas 205, the transceiver module 210, the memory 215, and the processor module 225.

FIG. 2B shows a block diagram of a wireless communications system 200b that includes an architecture of a femto-proxy system 290b that is different from the architecture shown in FIG. 2A. Similar to the femto-proxy system 290a, the femto-proxy system 290b includes an OOB proxy 240b and a FAP 230b. Unlike the system 290a, however, each of the OOB proxy 240b and the FAP 230b has its own antenna 205, transceiver module 210, memory 215, and processor module 225. Both transceiver modules 210 are configured to communicate bi-directionally, via their respective antennas 205, with ATs 115. The transceiver module 210-1 of the FAP 230b is illustrated in bi-directional communication with the macro communications network 100b (e.g., typically over a backhaul network).

For the sake of illustration, the femto-proxy system 290b is shown without a separate communications management subsystem 250. In some configurations, a communications management subsystem 250 is provided in both the OOB proxy 240b and the FAP 230b. In other configurations, the communications management subsystem 250 is implemented as part of the OOB proxy 240b. In still other configurations, functionality of the communications management subsystem 250 is implemented as a computer program product (e.g., stored as software 220-1 in memory 215-1) of one or both of the OOB proxy 240b and the FAP 230b.

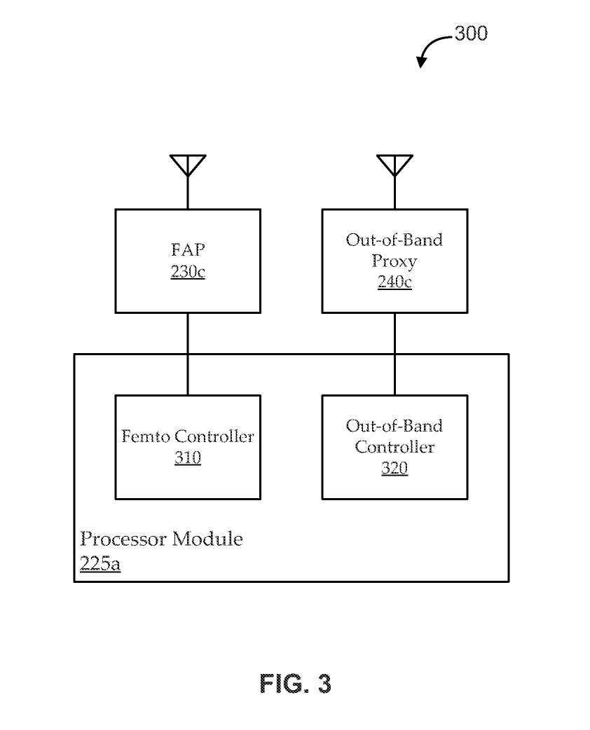

In yet other configurations, some or all of the functionality of the communications management subsystem 250 is implemented as a component of the processor module 225. FIG. 3 shows a block diagram 300 of a processor module 225a for implementing functionality of the communications management subsystem 250. The processor module 225a includes a femto controller 310 and an OOB controller 320. The femto controller 310 is in communication with and directs certain functionality of the FAP 230c, while the OOB controller 320 is in communication with and directs certain functionality of the OOB proxy 240c. As described above, the FAP 230c may be a femtocell, and the OOB proxy 240c may be an OOB radio. As described more fully below, configurations of the OOB controller 320 detect proximity of authorized ATs 115 using the OOB proxy 240c to determine whether each AT 115 is in a coverage area associated with the FAP 230c.

Both the FAP 230a of FIG. 2A and the FAP 230b of FIG. 2B are illustrated as providing a communications link only to the macro communications network 100a. However, the FAP 230 may provide communications functionality via many different types of networks and/or topologies. For example, the FAP 230 may provide a wireless interface for a cellular telephone network, a cellular data network, a local area network (LAN), a metropolitan area network (MAN), a wide area network (WAN), the public switched telephone network (PSTN), the Internet, etc.

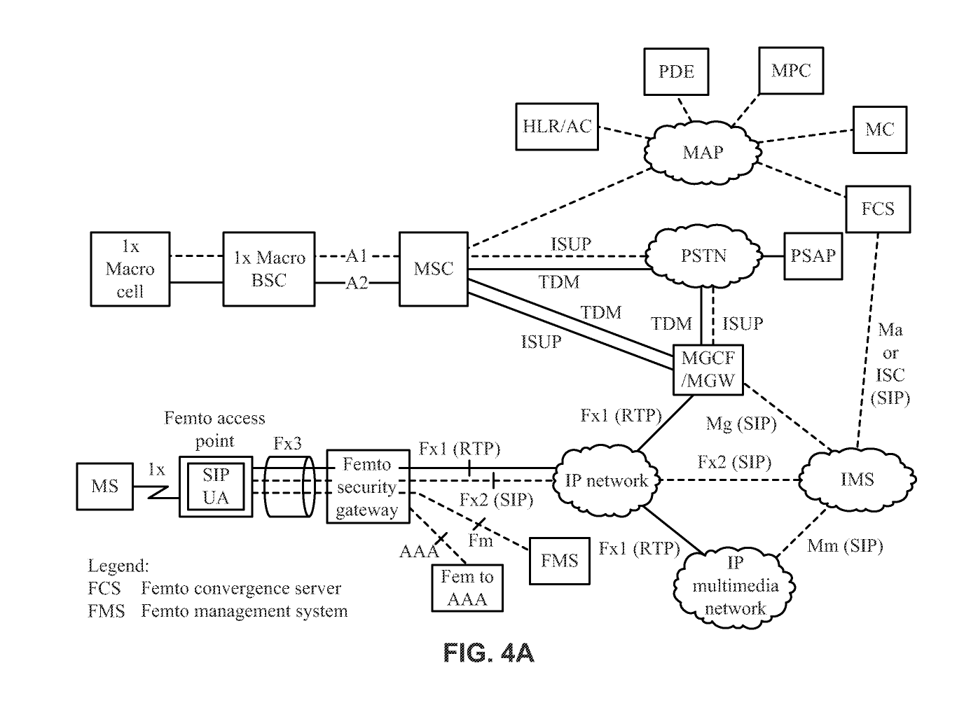

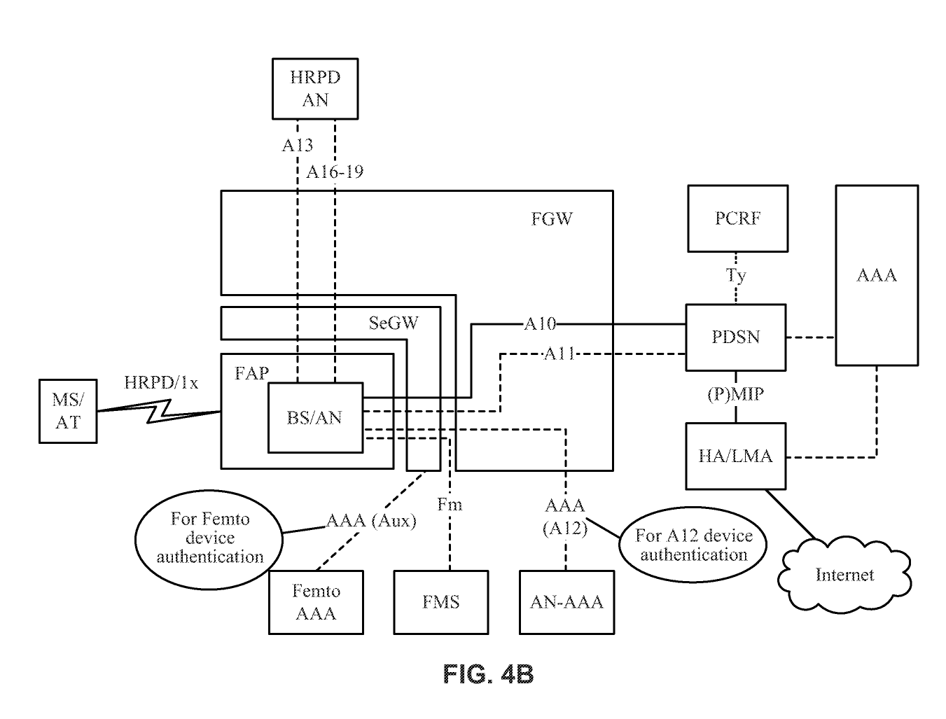

FIGS. 4A and 4B show further detail with respect to femtocell architecture in communication networks for providing various services. Specifically, FIG. 4A shows detail regarding an exemplary femtocell architecture for legacy circuit services. For example, the network of FIG. 4A may be a CDMA 1x circuit switched services network. FIG. 4B shows detail regarding an exemplary femtocell architecture for packet data service access using legacy interfaces. For example, the network of FIG. 4B may be a 1x EV-DO (HRPD) packet data services network. These architectures illustrate possible portions of the communications systems and networks shown in FIGS. 1-3.

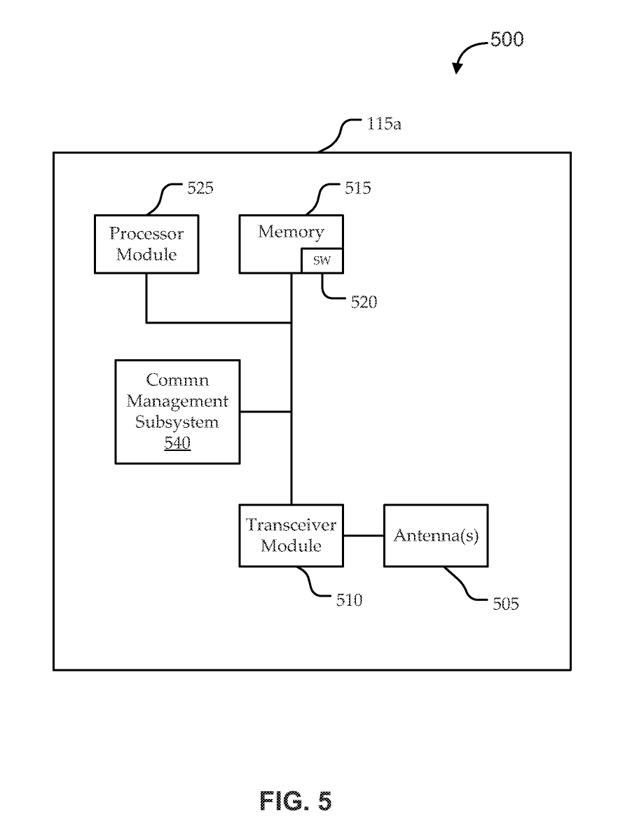

As described above, the femto-proxy systems 290 are configured to communicate with client devices, including the ATs 115. FIG. 5 shows a block diagram 500 of a mobile access terminal (AT) 115a for use with the femto-proxy systems 290 of FIGS. 2A and 2B in the context of the communications systems and networks of FIGS. 1-4B. The AT 115a may have any of various configurations, such as personal computers (e.g., laptop computers, netbook computers, tablet computers, etc.), cellular telephones, PDAs, digital video recorders (DVRs), internet appliances, gaming consoles, e-readers, etc. For the purpose of clarity, the AT 115a is assumed to be provided in a mobile configuration, having an internal power supply (not shown), such as a small battery, to facilitate mobile operation.

The AT 115a includes antennas 505, a transceiver module 510, memory 515, and a processor module 525, which each may be in communication, directly or indirectly, with each other (e.g., via one or more buses). The transceiver module 510 is configured to communicate bi-directionally, via the antennas 505 and/or one or more wired or wireless links, with one or more networks, as described above. For example, the transceiver module 510 is configured to communicate bi-directionally with BTSs 105 of the macro communications network (e.g., the communications system 100 of FIG. 1), and, in particular, with at least one FAP 230.

As described above, the transceiver module 510 may be configured to further communicate over one or more OOB channels. For example, the transceiver module 510 communicates with a femto-proxy system 290 (e.g., as described with reference to FIGS. 2A and 2B) over both an in-band (e.g., macro) link to the FAP 230 and at least one OOB channel to the OOB proxy 240. The transceiver module 510 may include a modem configured to modulate the packets and provide the modulated packets to the antennas 505 for transmission, and to demodulate packets received from the antennas 505. While the AT 115a may include a single antenna 505, the AT 115a will typically include multiple antennas 505 for supporting multiple links or channels.

The memory 515 may include random access memory (RAM) and read-only memory (ROM). The memory 515 may store computer-readable, computer-executable software code 520 containing instructions that are configured to, when executed, cause the processor module 525 to perform various functions described herein (e.g., call processing, database management, message routing, etc.). Alternatively, the software 520 may not be directly executable by the processor module 525 but be configured to cause the computer, when compiled and executed, to perform functions described herein.

The processor module 525 may include an intelligent hardware device, for example, a central processing unit (CPU) such as those made by Intel® Corporation or AMD®, a microcontroller, an application specific integrated circuit (ASIC), etc. The processor module 525 may include a speech encoder (not shown) configured to receive audio via a microphone, convert the audio into packets (e.g., 30 ms in length) representative of the received audio, provide the audio packets to the transceiver module 510, and provide indications of whether a user is speaking Alternatively, an encoder may only provide packets to the transceiver module 510, with the provision or withholding/suppression of the packet itself providing the indication of whether a user is speaking

According to the architecture of FIG. 5, the AT 115a further includes a communications management subsystem 540. The communications management subsystem 540 may manage communications with the macro (e.g., WWAN) network, one or more OOB networks (e.g., piconets, OOB proxies 240, etc.), one or more femtocells (e.g., FAPs 230), other ATs 115 (e.g., acting as a master of a secondary piconet), etc. For example, the communications management subsystem 540 may be a component of the AT 115a in communication with some or all of the other components of the AT 115a via a bus. Alternatively, functionality of the communications management subsystem 540 is implemented as a component of the transceiver module 510, as a computer program product, and/or as one or more controller elements of the processor module 525.

The AT 115a includes communications functionality for interfacing with both the macro (e.g., cellular) network and one or more OOB networks (e.g., the OOB proxy 240 channel). For example, some ATs 115 include native cellular interfaces as part of the transceiver module 510 or the communications management subsystem 540 (e.g., a transceiver utilizing cellular network communication techniques that consume relatively large amounts of power in operation) for communicating with other appropriately configured devices (e.g., for establishing a link with a macro communication network via FAP 230) through a native cellular wireless link. The native cellular interfaces may operate according to one or more communication standards, including, but not limited to, W-CDMA, CDMA2000, GSM, WiMax, and WLAN.

Furthermore, the ATs 115 may also include OOB interfaces implemented as part of the transceiver module 510 and/or the communications management subsystem 540 (e.g., a transceiver that may consume relatively low amounts of power in operation and/or may cause less interference than in the in-band spectrum) for communicating with other appropriately configured devices over a wireless link. One example of a suitable OOB communication interface is a Bluetooth-compliant transceiver that uses a time-division duplex (TDD) scheme.

Out-of-Band Paging Embodiments

In a typical femto deployment, multiple ATs 115 may be authorized to communicate with a FAP 230 according to an access control list (ACL) maintained by the FAP 230. In order to maintain communications links with those ATs 115 as appropriate (e.g., to facilitate idle macro-to-femto handoffs, active macro-to-femto hand-ins, etc.), the FAP 230 may determine when an authorized AT 115 enters or leaves a coverage area associated with the FAP 230 by monitoring each AT's 115 proximity to the FAP 230.

Notably, the WWAN link between the FAP 230 and each AT 115 is negotiated according to a managed network protocol, such that timing and/or other parameters of the communications are negotiated. Accordingly, using WWAN (e.g., cellular) techniques to monitor proximity may allow exploitation of the negotiated parameters for the sake of for fairness, efficiency, etc. However, using the WWAN link for proximity detection by configuring the AT 115 to send periodic registrations to the FAP 230 may also undesirably impact battery life of the AT 115. Also, this can be configured only after the AT 115 has performed handoff to the FAP 230. In some configurations, the approach might detect when the AT 115 entered a femto coverage area precisely but not when the AT 115 has exited the femto coverage area.

As described above, a femto-proxy system 290 provides both in-band and out-of-band (OOB) functionality through its integrated FAP 230 and OOB proxy 240, respectively. Exemplary femto-proxy 290 implementations use the OOB proxy 240 to detect proximity of each AT 115 in an access control list of its associated FAP 230 to help facilitate establishment or termination of WWAN links between the FAP 230 and the ATs 115, as appropriate. For example, the OOB proxy 240 may periodically communicate proximity request messages to each AT 115 and wait for a proximity response message or a timeout condition indicating whether each AT 115 is in proximity.

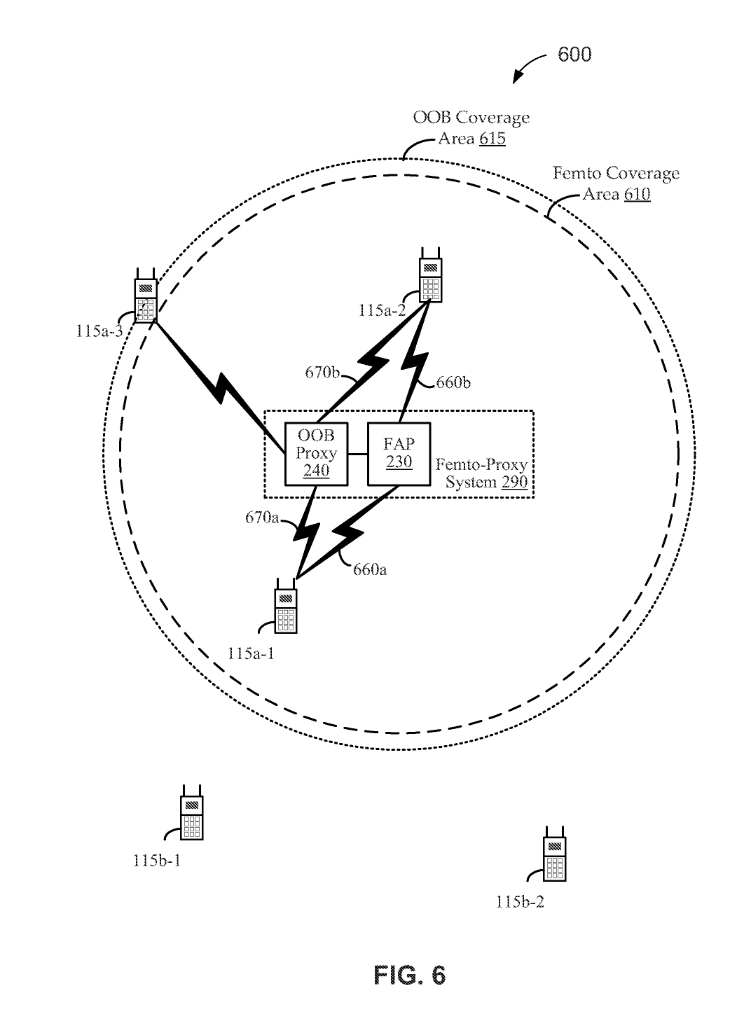

Turning to FIG. 6, a simplified network environment 600 illustrates an exemplary scenario in which multiple ATs 115 are in different locations and communication states with respect to a femto-proxy system 290. The femto-proxy system 290 is shown in simplified form as a FAP 230 integrated with an OOB proxy 240. A femto coverage area 610 is illustrated around the FAP 230, and five ATs 115 are shown in various locations with respect to the femto coverage area 610. It will be appreciated that the locations, numbers, sizes, and other aspects of the illustrated elements in FIG. 6 are intended to be illustrative only, and should not be construed as limiting the scope of the disclosure or the claims.

Among the ATs 115 illustrated in FIG. 6, a first subset of ATs 115a is considered “in proximity” to the FAP 230 for the sake of this disclosure. Some ATs 115a in proximity to the FAP 230 may be in an active communications mode while attached to the FAP 230, such that each has an established in-band link 660 with the FAP 230. Other ATs 115a in proximity to the FAP 230 are in an inactive (or idle) communications mode while attached to the FAP 230 (e.g., the FAP 230 periodically monitors overhead and paging channels, but no in-band link 660 is maintained).

A second subset of ATs 115b is considered “out of proximity” or “not in proximity” to the FAP 230 for the sake of this disclosure. For example, AT 115b-1 and AT 115b-2 are shown completely outside the femto coverage area 610 (e.g., and outside the range of the OOB proxy 240, as described below). As both of the second subset of ATs 115b are out of proximity to the FAP 230 and outside both the femto coverage area 610 and the OOB coverage area 615, neither can have an established in-band link 660 with the FAP 230 or an established OOB channel 670 with the OOB proxy 240, and both are out of range to receive any OOB messaging (e.g., paging requests).

Regarding the first subset of ATs 115a, AT 115a-1 and AT 115a-2 are assumed to be within the femto coverage area 610, attached to the FAP 230, and in an active communications mode. Accordingly, each is in communication with the femto-proxy system 290 over at least an in-band (e.g., WWAN, cellular) link 660 with the FAP 230. As described above, the in-band link 660 can be used to facilitate macro communications with the ATs 115.

For the sake of illustration, an OOB coverage area 615 is also shown. For example, the OOB coverage area 615 may be dictated by the OOB range (e.g., the Bluetooth range). Configurations of the ATs 115 are configured to be in communication with the OOB proxy 240 of the femto-proxy system 290 over an OOB (e.g., Bluetooth) channel 670. In some implementations, the OOB channel 670 is a predetermined frequency or set of frequencies (e.g., a range of contiguous frequencies or a set on non-contiguous frequencies) over which OOB communications occur. During paging and/or other types of communications, it may be unnecessary to establish an OOB link over the OOB channel 670.

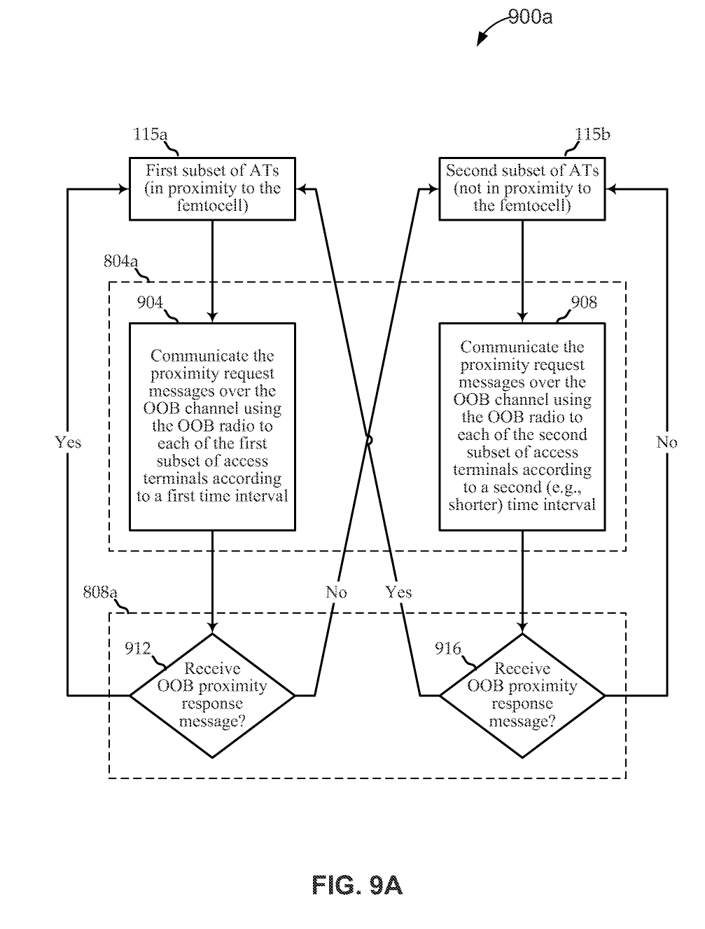

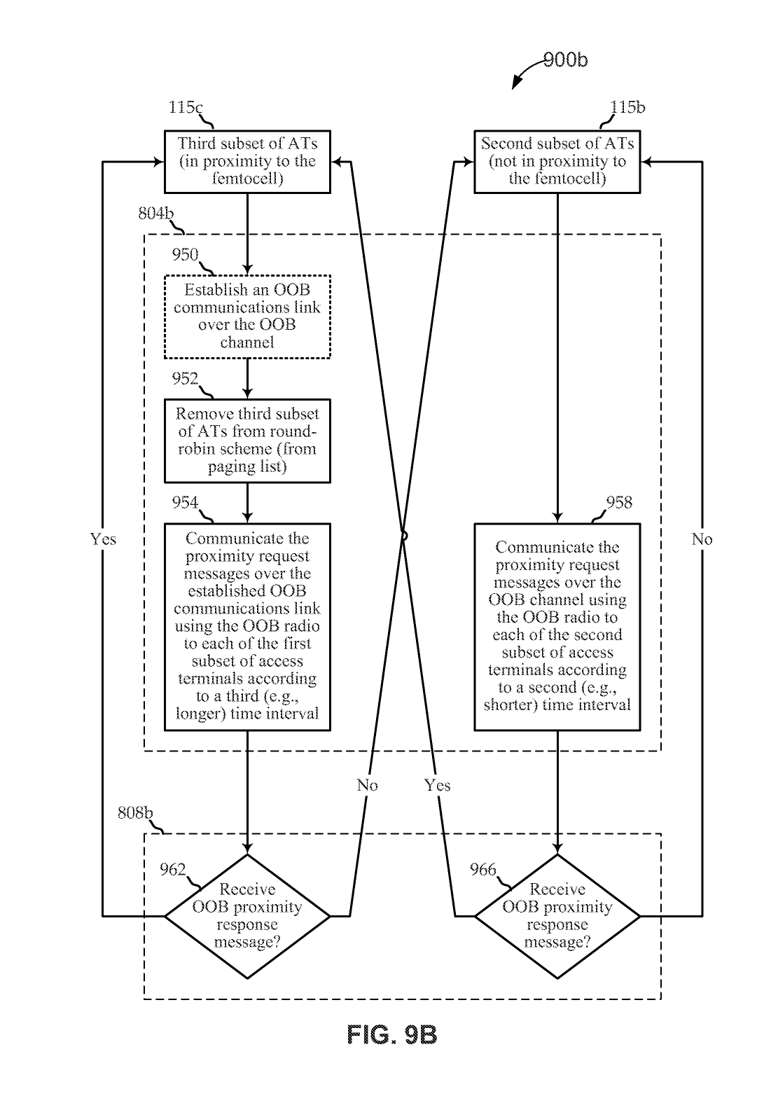

For example, some of the ATs 115a in proximity are in communication with the OOB proxy 240 using periodic proximity request and response messages. Other of the ATs 115a in proximity may have an OOB link established over the OOB channel 670. In one example, the OOB link is established to facilitate a “polling,” rather than a paging implementation (e.g., as described below with reference to FIG. 9A). In another example, the OOB link is established over the OOB channel 670 to provide supplemental communications functionality (e.g., proximity detection, supplemental bandwidth, etc.).

Typically, the OOB coverage area 615 is configured to be substantially coextensive with the femto coverage area 610 (e.g., the difference in coverage area illustrated in FIG. 6 is exaggerated for the sake of clarity). For example, when the two coverage areas are substantially coextensive, OOB proximity detection can reliably indicate presence within the femto coverage area 610 (i.e., and proximity to the FAP 230). Accordingly, an AT 115 may be discovered by the OOB proxy 240 over an OOB channel 670 when the AT 115 is immediately outside or within the femto coverage area 610. To illustrate this case, AT 115a-3 is shown as being located just outside the femto coverage area 610 and having no established in-band link 660 with the FAP 230; but still being within the OOB range and having an established OOB channel 670 with the OOB proxy 240.

For example, when the AT 115a-3 approaches the femto coverage area 610 (e.g., but has not yet entered the femto coverage area 610), the AT 115 receives a proximity request message (e.g., a Bluetooth paging message) from the OOB proxy 240 and responds with a proximity response message to the OOB proxy 240. Having discovered the AT 115 over the OOB channel 670, the FAP 230 may be informed that it is highly likely that the AT 115 is in proximity to the FAP 230. Accordingly, a scan may commence (e.g., at the AT 115 or the FAP 230) over an in-band channel, so that the AT 115 and the FAP 230 can discover each other. If the AT 115 is in active communications, when the scan is successful (e.g., when the AT 115 is within the femto coverage area 610), an in-band link 660 may be established between the AT 115 and the FAP 230, when appropriate.

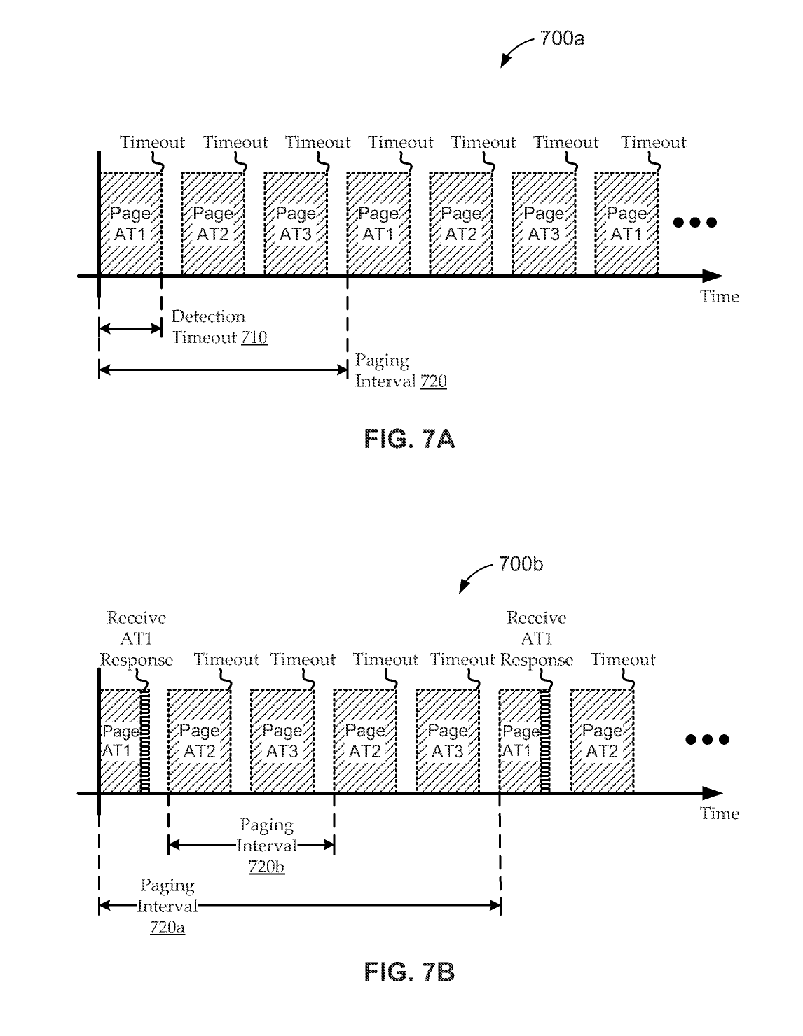

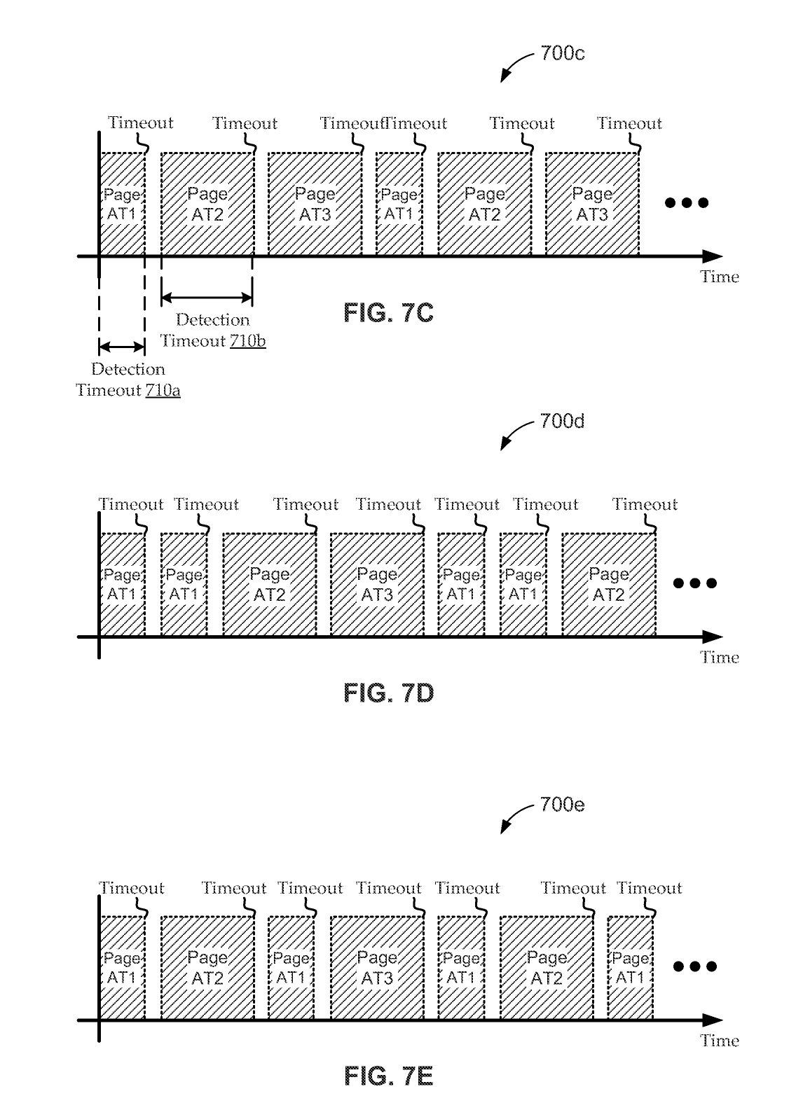

FIGS. 7A-7E illustrate various novel techniques for using the OOB proxy 240 for proximity detection of ATs 115 over an OOB channel 670, as described with reference to FIG. 6. It is worth noting that, while the term “page” often indicates Bluetooth paging, paging is used herein generally to indicate communication of a proximity request message to an AT 115 using any type of unmanaged OOB protocol over any type of OOB channel 670, including, but not limited to, Bluetooth. Further, for the sake of simplicity, FIGS. 7A-7E assume that only three ATs 115 are in the ACL of the FAP 230.

Turning first to FIG. 7A, a simplified signaling diagram 700a is shown, in which a round-robin scheme is used for proximity detection over an OOB channel 670. Over time, the OOB proxy 240 communicates proximity request messages to each of the ATs 115 in the ACL of the FAP 230 integrated with the OOB proxy 240 as part of a femto-proxy system 290. As illustrated, each AT 115 is paged according to a round-robin scheme. A proximity request message is communicated to each AT 115. After each proximity request message is communicated (or begins to be communicated, as described below), the OOB proxy 240 is configured to wait a certain amount of time (a “detection timeout” 710) for a proximity response message from the paged AT 115. If no response message is received before the “detection timeout” 710, detection of the paged AT 115 times out, indicating that the paged AT 115 is not in proximity.

Note that the paging process is simplified herein for the sake of clarity. For example, according to some Bluetooth implementations, communication of “a proximity request message” to the AT 115 actually includes communication of a number of messages. In some exemplary implementation, the OOB proxy 240 communicates an “A Train” of paging messages “Npage” times (typically 128 times or 256 times, depending on the implementation) or until a paging response is received; and, if no response is received, the OOB proxy 240 communicates a “B Train” of paging messages Npage times or until a paging response is received. The “A” and “B” messaging trains may be communicated alternately until a response is received or the detection timeout 710 is reached or exceeded. In one such exemplary implementation, each messaging train takes ten milliseconds to send, so that it would take 5.12 seconds to alternate the “A” and “B” trains twice, using an Npage value of 128. Accordingly, the detection timeout 710 may be set to 5.12 seconds in certain configurations.

According to some configurations, the round-robin scheme includes paging intervals 720. For example, as illustrated, the paging interval 720 for “AT1” may be an amount of time from when a proximity request message is communicated to “AT1” until a next proximity request message is communicated to “AT1.” In the exemplary round-robin scheme of FIG. 7A, the detection timeouts 610 and paging intervals 620 are substantially equal for all three ATs 115 in the ACL of the FAP 230. Accordingly, the OOB proxy 240 pages each AT 115 once per cycle, spending substantially the same amount of time attempting to detect each AT 115.

For example, in a typical Bluetooth implementation, the OOB proxy 240 is a Bluetooth radio that pages all ATs 115 in the ACL according to their respective Bluetooth identifiers (e.g., BD ADDRs) and according to the round-robin scheme. In some configurations, each Bluetooth device enters a page scan state for 11.25 milliseconds every 1.28 seconds or every 2.56 seconds, depending on the page scan mode being used. When the AT 115 is in proximity and enters page scan mode, the AT 115 receives a page packet from the OOB proxy 240 and sends back a page response. When the OOB proxy 240 receives the page response, the associated FAP 230 can consider the AT 115 to be in its proximity.

It will be appreciated from the above descriptions that communication of the proximity detection message may actually involve substantially continuous communication of a sequence of page trains (as in Bluetooth implementations) until the detection timeout 710 is reached or until a response is received. Accordingly, the detection timeout 710 may be set as some amount of time after a particular set of proximity detection messages begins to be communicated. For example, the detection timeout 710 may be the amount of time the FAP 230 will continue to page an AT 115 before aborting the paging procedure (e.g., and moving on to paging the next AT 115 in the round-robin sequence).

Exemplary configurations are implemented with the OOB proxy 240 at the femto-proxy 290 paging the ATs 115, rather than the ATs 115 paging the OOB proxy 240. This may allow implementation without changing the ATs 115, and more centralized handling of detection of multiple ATs 115 in an ACL. Notably, the implementation by which the OOB proxy 240 pages the ATs 115 can appreciably impact latencies associated with the detection. When the OOB proxy 240 pages multiple phones in a round-robin fashion, there will be latencies experienced by each AT 115 for proximity detection. For example, the latency may depend on the values of the detection timeouts 710 and the number of ATs 115 to be paged (e.g., and possibly also the paging interval 720, as described more fully below). It may be desirable, therefore, to configure the round-robin scheme to balance maximizing detection reliability against minimizing overall detection latencies.

Notably, the OOB channel 670 may be established according to an unmanaged (e.g., ad hoc, peer-to-peer) protocol, such that parameters of the communications channel may not be negotiated. These non-negotiated parameters may include detection timeouts 710, paging intervals 720, etc. Using the round-robin scheme of FIG. 7A may allow for discovery of ATs 115 in proximity to a FAP 230 using a lower power OOB channel 670, even over an unmanaged OOB channel 670. Further, such a scheme may be considered fair to all the ATs 115, as the OOB proxy 240 spends substantially the same amount of time detecting proximity of each AT 115 in the ACL.

However, as discussed above, when multiple ATs 115 are authorized to communicate with a FAP 230, each AT 115 may be configured with different OOB implementations. For example, each AT 115 may be configured according to one of multiple Bluetooth stack implementations, particularly in a “scatternet” context. These different OOB implementations may cause the ATs 115 to manifest different response times to proximity request messages, and/or other differences that may affect discovery of the AT 115. Accordingly, reliable discovery of all the ATs 115 in the ACL using a scheme like the one illustrated by FIG. 7A may involve configuring the detection timeout 710 to have a worst-case duration (e.g., the longest detection timeout 720 needed to give the worst OOB implementation adequate time to respond). Less efficient OOB implementations may receive more favorable treatment at the expense of more efficient OOB implementations, which may be inefficient and may be considered unfair.

Various modifications may be made to the round-robin scheme to improve reliability, efficiency, and/or fairness. One modification is illustrated by the simplified signaling diagram 700b of FIG. 7B. As described with reference to FIG. 6, some ATs 115 on the ACL may be in proximity to the FAP 230 (e.g., illustrated as ATs 115a in FIG. 6), while other ATs 115 on the ACL may be out of proximity to the FAP 230 (e.g., illustrated as ATs 115b in FIG. 6).

For the sake of illustration, a first of the three ATs 115 (designated as “AT1”) is assumed to be in proximity of the FAP 230. Accordingly, at some time after the OOB proxy 240 communicates the proximity request message to “AT1,” the OOB proxy 240 receives a proximity response message from “AT1” (rather than timing out). Notably, FIG. 7B illustrates the response as being received at some time during the paging sequence, but the response may be received at any time during the paging sequence. According to typical configurations, the round-robin scheme is determined according to the detection timeouts 710 and paging intervals 720; but, as illustrated, receipt of a response from “AT1” may effectively shorten the detection timeout 710 period for “AT1” which may cause the paging of “AT2” to begin sooner.

According to some configurations, after an AT 115 is detected in proximity to the FAP 230, that AT 115 is paged less often. For example, once an in-band link 660 is established with the FAP 230, or while the AT 115 continues to send back paging responses, the AT 115 is paged only to see if it is no longer in proximity. However, other mechanisms may already be available for handling communications with ATs 115 leaving proximity, for example, including idle and active femto-to-macro hand-out techniques.

As illustrated in FIG. 7B, after paging “AT1,” a proximity response message is received, indicating that “AT1” is in proximity to the FAP 230. While the paging interval 720b for “AT2” and “AT3” remains substantially the same, the paging interval 720a for “AT1” is extended, such that “AT1” is paged half as often as either“AT2” or “AT3.” Effective doubling of “AT1”'s paging interval 720a is only one illustrative type of adjustment that may be made to the paging interval. For example, the paging interval 720a may be further extended or otherwise changed.

According to one exemplary scenario, the OOB proximity detection is implemented using Bluetooth (e.g., as described above with reference to FIG. 7A). For the sake of simplicity, it is assumed that no other Bluetooth connections are present (e.g., no Synchronous Connection-Oriented (SCO) link is present, for example, between the AT 115 and a Bluetooth headset). The OOB proxy 240 pages the ATs 115 in the ACL according to a round-robin scheme using a particular first paging interval 720b. At some time, a particular AT 115 is detected in proximity (e.g., when a page response message is received by the OOB proxy 240), and the OOB proxy 240 continues to page the other ATs 115 at the first paging interval 720b, while paging the particular AT 115 according to a second, longer paging interval 720a (i.e., the particular AT 115 in proximity is paged less frequently). When the particular AT 115 leaves proximity (e.g., when a page no longer results in a response), the OOB proxy 240 returns to detecting the particular AT 115 according to the first paging interval 720b.

Notably, the round-robin scheme of FIG. 7B may be more efficient than that of FIG. 7A in certain contexts by adjusting the paging interval 720 according to proximity of the ATs 115. However, the scheme of FIG. 7B may still exhibit similar limitations as those of FIG. 7A, such as inefficiencies and fairness issues relating to differing OOB implementations among the ATs 115. Accordingly, some configurations include round-robin schemes having detection timeouts 710 adjusted according to characteristics of each AT 115.

FIG. 7C shows a simplified signaling diagram 700c illustrating one such round-robin scheme in which detection timeouts 710 are adjusted according to characteristics of each AT 115. As discussed above, different OOB implementations may manifest different response times and/or other characteristics that may affect the amount of time needed for reliable proximity detection. Adjusting the detection timeout 710 for each AT 115 may help account for some of these variations in OOB implementation.

Various techniques may be used to determine an appropriate detection timeout 710 for each AT 115. As discussed with reference to FIGS. 7A and 7B, a worst-case value may be assumed and used for the round-robin scheme. According to other techniques, the femto-proxy system 290 may determine a non-dynamic characteristic of the AT 115, such as its make and/or model. For example, a database may be accessible to the femto-proxy system 290, in which each of various non-dynamic characteristics of the AT 115 is associated with a preset detection timeout 710. The femto-proxy system 290 (e.g., the FAP 230 and/or the OOB proxy 240) may look up the non-dynamic characteristic of the AT 115 in the database to set the detection timeout 710 to an appropriate value. The database may be located at the femto-proxy system 290, at a centralized location (e.g., at a femto convergence server disposed in a core network), etc.

In one implementation, during initial pairing of the AT 115 with the FAP 230, a mapping is made between the Bluetooth address (e.g., BD ADDR) and the IMSI of the AT 115. The Bluetooth address is then used to determine non-dynamic characteristics directly (e.g., the manufacturer may be indicated as part of the BD ADDR), and/or indirectly (e.g., as an intermediate lookup in a database). These non-dynamic characteristics and/or other information are then used to determine an appropriate detection timeout 710 by looking up the appropriate data in an associative or other type of database.

According to yet other techniques, information about the AT 115 is manually entered by a user. For example, a user enters relevant AT 115 information as part of a registration process, on an AT 115 interface, on a femto-proxy system 290 interface, via a web portal, by phone, etc. The entered AT 115 information may include non-dynamic information (e.g., model information, OOB implementation information, etc.) and/or dynamic information (e.g., results of experimentation, etc.).

According to still other techniques, the detection timeout 710 is dynamically determined and/or updated for each AT 115. According to one such exemplary technique, when the AT 115 initially registers with the OOB proxy 240, a test proximity request message is communicated, and the OOB proxy 240 measures the amount of time before a corresponding proximity response message is received. That amount of time (e.g., or a closest selection from among a set of predetermined durations) is used as the detection timeout 710 of the AT 115. According to another such exemplary technique, each time the OOB proxy 240 communicates a proximity request message to the AT 115, the OOB proxy 240 measures the amount of time before a corresponding proximity response message is received. The detection timeout 710 is dynamically adjusted accordingly, as desired.

It is worth noting that multiple OOB implementations may be optimally served by substantially identical detection timeouts 710, particularly when the detection timeout 710 is selected from a limited set of options. For example, limiting the possible detection timeout 710 durations may also simplify determining round-robin schemes where both the detection timeouts 710 and the paging intervals 720 are adjusted.

As illustrated in FIG. 7C, it is assumed that the OOB implementations of “AT2” and “AT3” results in substantially the same detection timeout 710 (shown as detection timeout 710b). The detection timeout 710a for “AT1” however, is shown as being approximately half as long. Notably, by adjusting the detection timeouts 710 according to each AT's 115 OOB implementation, the detection latency may be reduced, for example, as compared with the round-robin schemes of FIG. 7A or 7B. For example, suppose the paging interval 720 in FIG. 7A is 15.4 seconds (i.e., approximately three-times a detection timeout 710 of 5.12 seconds to account for the three ATs 115 in the ACL); in FIG. 7C, the paging interval 720 may shrink to 12.8 seconds (i.e., approximately two detection timeouts 710b of 5.12 seconds for “AT2” and “AT3” and one detection timeout 710a of 2.56 seconds for “AT1”).

While a round-robin scheme link the one illustrated in FIG. 7C may reduce latency over a round-robin scheme having identical detection timeouts 710 for all ATs 115, the scheme may be considered unfair. ATs 115 having better OOB implementations are assigned smaller detection timeouts 710, resulting in less overall time being spent by the OOB proxy 240 in detecting those ATs 115. For example, in the illustrative implementation of FIG. 7C, half as much time is spent paging “AT1” as is spent paging either “AT2” or “AT3.”

FIGS. 7D and 7E show two exemplary approaches for addressing the potential fairness issue associated with adjusting the detection timeouts 710 according to each AT's 115 OOB implementation. Each implementation seeks to spend substantially the same average amount of time detecting each AT 115, even when different detection timeouts are used. For the sake of simplicity, a similar scenario to that of FIG. 7C is illustrated.

As illustrated in FIG. 7D, the round-robin scheme is adjusted so that “AT1” is paged twice in a row for each round-robin cycle. As described above, the detection timeout 710 of “AT1” is set to approximately one-half that of the other two ATs 115. For example, the detection timeouts 710b for “AT2” and “AT3” are set to 5.12 seconds, and the detection timeout 710a for “AT1” is set to 2.56 seconds. By paging “AT1” twice per round-robin cycle, approximately 5.12 seconds is spent paging each AT 115 during each round-robin cycle.

A similar, but alternative round-robin scheme is illustrated in FIG. 7E. As shown, the OOB proxy 240 pages “AT1” twice per round-robin cycle, but in a more uniform manner. As in FIGS. 7C and 7D, the detection timeout 710 of “AT1” is set to approximately one-half that of the other two ATs 115, such that paging “AT1” twice per round-robin cycle allows all ATs 115 to be paged for substantially the same average amount of time per round-robin cycle. In particular, the round-robin scheme shown in FIG. 7E pages in the following sequence: “AT1”; “AT2”; “AT1”; “AT3”; etc. This scheme may provide many of the same features as the scheme of FIG. 7D, but with a more uniform detection latency for “AT1.”

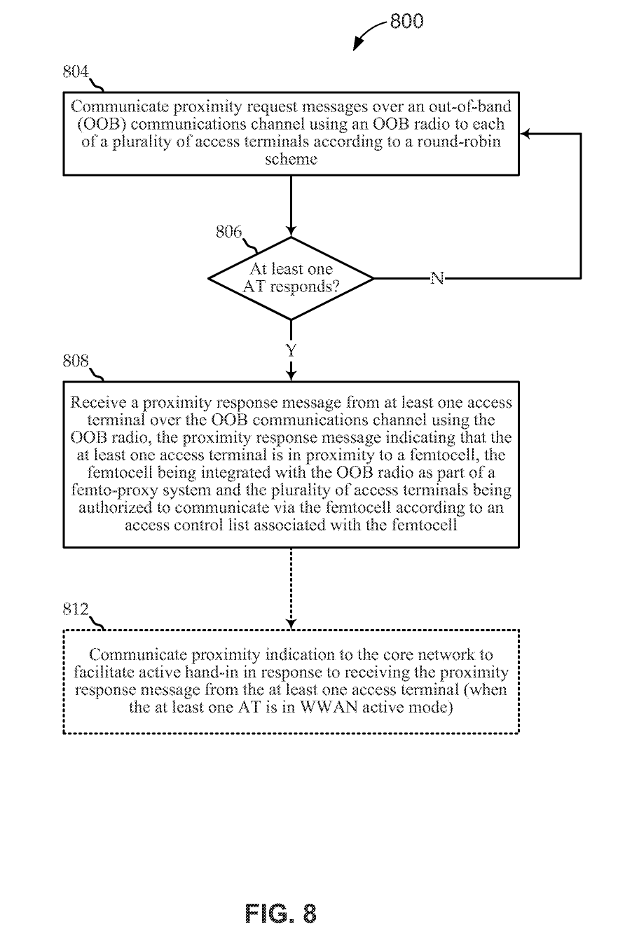

Femto-proxy systems 290, including the exemplary configurations described above, can be used to implement OOB proximity detection to support femto deployments. Some exemplary techniques for proximity detection are described with reference to FIGS. 7A-7E. These and other techniques are further described with reference to various methods of FIGS. 8-11. For the sake of clarity, each method is described in context of systems components described above.

Turning to FIG. 8, a flow diagram is shown of an exemplary method 800 for OOB proximity detection in a femto deployment. The method 800 begins at stage 804 by communicating proximity request messages over an out-of-band (OOB) communications link using an OOB radio to each of a plurality of access terminals according to a round-robin scheme. For example, a femto-proxy system 290 is provided having a femtocell (FAP 230) integrated with an OOB proxy 240. The FAP 230 maintains an access control list (ACL) that indicates a set of ATs 115 authorized to communicate (e.g., with the macro communications network) via the femtocell. In one illustrative configuration, OOB proxy 240 is implemented as a Bluetooth radio configured to communicate paging messages as proximity request messages over a Bluetooth communications link to each AT 115 in the ACL according to a round-robin scheme (e.g., as described more fully below with reference to FIGS. 7A-7E).

At stage 806, a determination is made as to whether any of the ATs 115 respond to the proximity request messages communicated in stage 804. If no ATs 115 respond, the method 800 may continue to page the ATs 115 according to the round-robin scheme per stage 804. When at least one AT 115 responds, at stage 808, a proximity response message is received from the at least one AT 115 over the OOB channel using the OOB radio. The proximity response message may be a paging response or any other similar type of response message. Receipt of the proximity response message indicates that the at least one AT 115 is in proximity to the FAP 230 integrated with the OOB radio (OOB proxy 240) as part of the femto-proxy system 290. For example, as described above, the femto-proxy system 290 is configured so that the OOB range is substantially coextensive with (e.g., or at least as large as) the femto coverage area 610, such that detection of the AT 115 over the OOB channel indicates proximity of the AT 115 to the FAP 230.

According to some configurations, at stage 812, a proximity indication is communicated to the core network (e.g., to the femto gateway, a femto convergence server, or other similar core network element) to facilitate active hand-in in response to receiving the proximity response message from the at least one access terminal. For example, the proximity indication is used by the core network to help improve reliability of active hand-in when the at least one AT 115 is in a WWAN active mode. When the AT 115 in in an idle communications mode, it may be unnecessary to communicate the proximity indication to the core network; still, some configurations may communicate the proximity indication to facilitate additional functionality.

In certain configurations, where enhanced ATs 115 are involved, it may be possible for the OOB proximity detection to affect operations of the AT 115. The AT 115 may autonomously perform idle handoff, or the AT 115 may initiate an active handoff procedure in response to the proximity detection. For example, after the OOB proximity detection occurs, the AT 115 may attempt to discover the FAP 230 (e.g., by measuring the signal strength on the FAP's 230 frequency). This may ultimately cause the AT 115 to hand off active communications from a source macro BTS 105 to the target FAP 230. In fact, this may cause the handoff to occur, even where the AT 115 would not otherwise have even searched for the FAP 230 (e.g., where the source macro BTS's 105 signal strength remains above a threshold), as the FAP 230 may be a more preferred cell according to a network setting.

Many variations to the method 800 are possible without departing from the scope of the disclosure or the claims. FIG. 9A shows a flow diagram of an exemplary method 900a for varying the method 800 of FIG. 8 to change paging intervals according to proximity of ATs 115. The method 900a begins with an exemplary implementation of stage 804 of FIG. 8 indicated as stage 804a, which is implemented as either stage 904 or 908 for each AT 115. As shown (and as illustrated and described with reference to FIG. 6), some implementations arise when a first subset of ATs 115a (e.g., one or more) is in proximity to the FAP 230, and a second subset of ATs 115b is not in proximity to the FAP 230.

For ATs 115a in the first subset (e.g., in proximity to the FAP 230), at stage 904, the OOB radio (e.g., OOB proxy 240) communicates the proximity request messages over the OOB channel to each access terminal according to a first time interval. For ATs 115b in the second subset (e.g., not in proximity to the FAP 230), at stage 908, the OOB radio communicates the proximity request messages over the OOB channel to each access terminal according to a second time interval. Typically, the second time interval is shorter than the first time interval.

The method 900a continues with an exemplary implementation of stage 808 of FIG. 8 indicated as stage 808a, which is implemented as either stage 912 or 916 for each AT 115. In either stage 912 or 916, it is determined whether an OOB proximity response message is received by the OOB proxy 240. According to stage 912, in the context of the first set of ATs 115a, a response is expected. Accordingly, if a response is received at stage 912, the AT 115 from which the response was received continues to be detected as a first subset AT 115a (e.g., according to stages 904 and 912); and, if no response is received at stage 912, the status of the AT 115 from which the response was not received changes (e.g., the AT 115 is considered to have left proximity) so that it is detected as a second subset AT 115b (e.g., according to stages 908 and 916). According to stage 916, in the context of the second set of ATs 115b, a response is not expected. Accordingly, if a response is not received at stage 916, the AT 115 from which the response was not received continues to be detected as a second subset AT 115b (e.g., according to stages 908 and 916); and, if a response is received at stage 916, the status of the AT 115 from which the response was received changes (e.g., the AT 115 is considered to have entered proximity) so that it is detected as a first subset AT 115a (e.g., according to stages 904 and 912).

For example, an AT 115 enters the femto coverage area 610 of the FAP 230, receives a proximity request message from the associated OOB proxy 240, and responds with a detection response message. The AT 115 is added to a list of first subset ATs 115a as being in proximity to the FAP 230. While in proximity, the OOB proxy 240 sends proximity request messages at some time interval to the AT and receives responses from the AT 115. At some point, the AT 115 leaves the femto coverage area 610. The next time the OOB proxy sends a proximity request message, no response is received. Accordingly, the AT 115 may be moved to the second subset of ATs 115b. While not in proximity, the OOB proxy 240 may send proximity request messages more often (i.e., at a second, shorter time interval), for example, so that the AT 115 is more quickly detected as being in proximity in the event that the AT 115 returns to the femto coverage area 610. An exemplary configuration of this technique is described above with reference to FIG. 7B.

Notably, the method of FIG. 9A uses paging over the OOB channel to detect when an AT 115 has entered or left proximity. In some cases, an OOB link may be established over the OOB channel. Certain configurations use the OOB link to communicate polling messages to the ATs 115, rather than polling those ATs 115 as part of the round-robin sequence. FIG. 9B shows a flow diagram of an exemplary method 900b for varying the method 800 of FIG. 8 by using polling over an OOB link to handle proximity detection of ATs 115.

The method 900b begins with an exemplary implementation of stage 804 of FIG. 8 indicated as stage 804b, which is implemented, for each AT 115, as either stages 950 and 954 or as stage 958. As shown, some implementations arise when a third subset of ATs 115c (e.g., one or more) is in proximity to the FAP 230, and a second subset of ATs 115b is not in proximity to the FAP 230.

Treatment of the second set of ATs 115b (e.g., not in proximity to the FAP 230) may be similar or identical to the treatment described in FIG. 9A. At stage 958, for ATs 115b in the second subset, the OOB radio communicates the proximity request messages over the OOB channel to each access terminal according to a second time interval. The proximity request messages may be paging requests.

The third subset of ATs 115c is identified as those ATs for which an OOB link has already been established over the OOB channel, or for which an OOB link will be established over the OOB channel to exploit the functionality of the method 900b. The third subset of ATs 115 may be the same as, may include, or may be separate from the first subset of ATs 115a described with reference to FIG. 9A. For example, the ATs 115 may already be engaged in data transfers and/or other communications with the femto-proxy system 290 that involves establishment of an OOB link. In the event that an OOB link has not already been established, one may be established at stage 950.

At stage 952, ATs 115c in the third subset (e.g., in proximity to the FAP 230) may be removed from the round-robin scheme subsequent to establishing the OOB link. For example, as discussed above, the round-robin scheme includes a set of ATs 115 being paged according to the scheme. The third subset of ATs 115c may be treated differently, thereby reducing the number of ATs 115 included in the paging list and potentially reducing the overall detection latency.

In particular, at stage 954, the OOB radio (e.g., OOB proxy 240) communicates the proximity request messages over the OOB communications link to each third subset AT 115c according to a third time interval. The third set of ATs 115c may be polled outside the round-robin scheme over the established OOB link. For example, polling packets can be sent over the OOB link as “keep alive” messages. The third interval at which the polling packets are communicated can be longer or shorter than the first interval described with reference to FIG. 9A, but will typically be longer than the second time interval.

The method 900 continues with an exemplary implementation of stage 808 of FIG. 8 indicated as stage 808a, which is implemented as either stage 962 or 966 for each AT 115. In either stage 962 or 966, it is determined whether an OOB proximity response message is received by the OOB proxy 240. According to stage 962, in the context of the third set of ATs 115c, a response is expected (e.g., in the form of a polling response packet). Accordingly, if a response is received at stage 962, the AT 115 from which the response was received continues to be detected as a third subset AT 115c (e.g., according to stages 950, 954, and 962). If no response is received at stage 962, the status of the AT 115 from which the response was not received changes (e.g., the AT 115 is considered to have left proximity) so that it is detected as a second subset AT 115b (e.g., according to stages 958 and 966).

According to stage 966, in the context of the second set of ATs 115b, a response is not expected. Accordingly, if a response is not received at stage 966, the AT 115 from which the response was not received continues to be detected as a second subset AT 115b (e.g., according to stages 958 and 966). If a response is received at stage 966, the status of the AT 115 from which the response was received changes (e.g., the AT 115 is considered to have entered proximity) so that it is detected as a third subset AT 115c (e.g., according to stages 950, 954, and 962).

One feature of the method 900b of FIG. 9B is that polling some ATs 115 over an established OOB link may reduce detection latencies when multiple ATs 115 are being detected. As more ATs 115 are added to the round-robin paging scheme of FIG. 9A, the overall detection latencies may increase. Conversely, removing ATs 115 from the set that is being paged as part of the round-robin scheme may reduce overall detection latencies. Using the techniques of FIG. 9B, when an OOB link is established with an AT 115, that OOB link can be used to poll the AT 115 without having to page the AT 115 as part of the round-robin scheme. Accordingly, more ATs 115 may be accommodated with lower detection latencies by exploiting all three subsets of ATs 115 discussed with reference to FIGS. 9A and 9B.

FIG. 9A shows movement of ATs 115 between the first subset and the second subset, and FIG. 9B shows movement of ATs 115 between the third subset and the second subset. Certain ATs 115 may also move between the first and third subsets. For example, it may be desirable to page all proximate ATs 115 as part of the round-robin scheme (i.e., keep them as part of the first subset of ATs 115a) when the total number of proximate ATs 115 remains or falls below some number (e.g., three). Alternately, it may be desirable to move ATs 115 to the third subset of ATs 115c whenever an OOB link in established for any reason.

In addition to, or as an alternative to, adjusting the paging intervals, the round-robin scheme may be modified by adjusting detection timeouts. To detect each AT 115, the OOB proxy 240 may send proximity request messages for some time until a response is received or a detection timeout is reached. Some exemplary implementations that use and adjust detection timeouts are described above with reference to FIGS. 7C-7E.

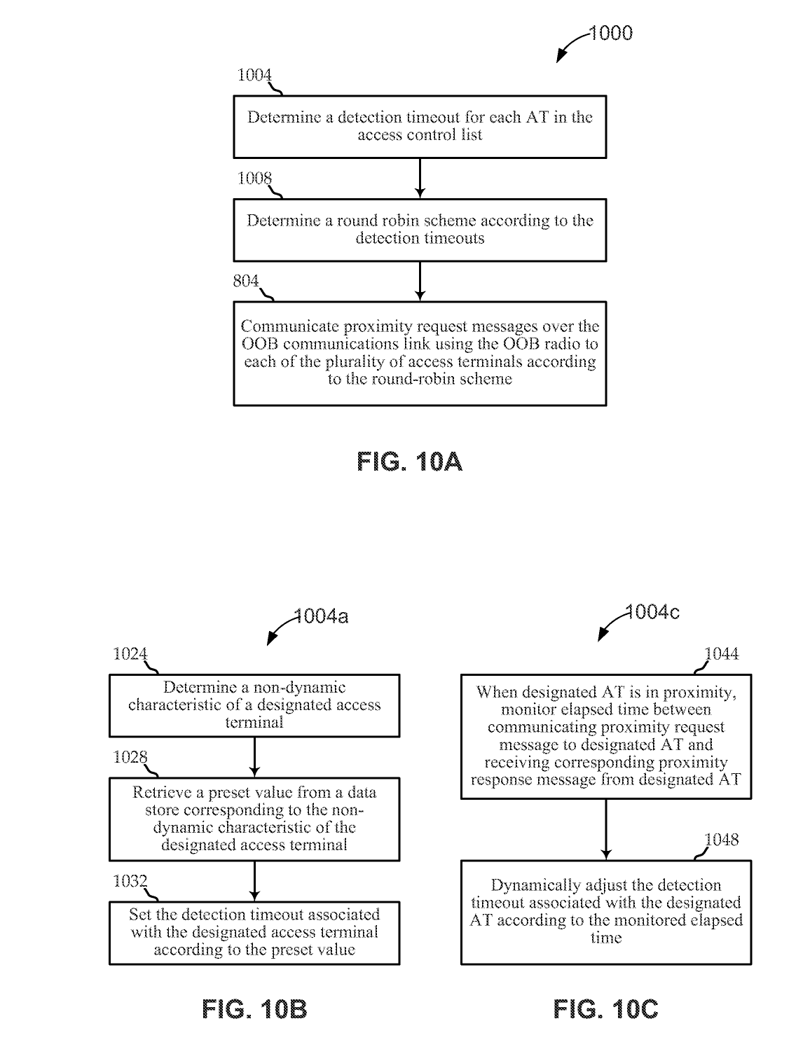

FIG. 10A shows a flow diagram of an exemplary method 1000 for implementing OOB proximity detection using adjusted detection timeouts. The method 1000 begins at stage 1004 by determining a detection timeout for each AT 115 in the access control list. At stage 1008, a round robin scheme is determined according to the detection timeouts for the ATs 115. Having determined a round-robin scheme, proximity request messages are communicated over the OOB channel using the OOB radio to each of the plurality of access terminals according to the round-robin scheme, for example, according to stage 804 of FIG. 8.

There are many different techniques for determining an appropriate detection timeout for each AT 115 according to stage 1004. FIG. 10B shows a flow diagram of an exemplary method 1004a for determining an appropriate detection timeout for each AT 115 (e.g., according to an implementation of stage 1004 of FIG. 10A). The method 1004a begins at stage 1024 by determining a non-dynamic characteristic of a designated AT 115. The non-dynamic characteristic may be a make, model, OOB implementation, OS version, or any other substantially unchanging information about the AT 115 that can be useful in determining an appropriate detection timeout. For example, the make or model of a mobile handset may indicate its OOB implementation.

At stage 1028, a preset value is retrieved from a data store corresponding to the non-dynamic characteristic of the designated AT 115. The data store may be a database or any other data storage type or location from which the detection timeout can be retrieved, derived, etc. For example, the FAP 230 is in communication with a central server that has a lookup table of appropriate detection timeout values for each of a listing of AT 115 models, and a default value for any AT 115 model not on the list. At stage 1032, the detection timeout may be associated with the designated AT 115 according to the preset value.

FIG. 10C shows a flow diagram of another exemplary method 1004b for determining an appropriate detection timeout for each AT 115 (e.g., according to another implementation of stage 1004 of FIG. 10A). The method 1004b begins at stage 1044 by monitoring an elapsed time between communicating a proximity request message to the designated AT 115 (i.e., that is known to be in proximity to the FAP 230) and receiving a corresponding proximity response message from the designated AT 115. For example, the OOB proxy 240 pages the AT 115 and monitors how long it takes for the AT 115 to respond. In one configuration, a timer is started upon commencing paging the AT 115, and the timer is stopped when a response is received.

At stage 1048, the detection timeout associated with the designated AT 115 is dynamically adjusted according to the monitored elapsed time. For example, the AT 115 may have a current value from prior tests, manual input, database lookups, etc. that is dynamically adjusted (e.g., one or more times) according to the monitored elapsed time. In certain configurations, one of a set of possible detection timeout values is selected to most closely approximate the monitored elapsed time.

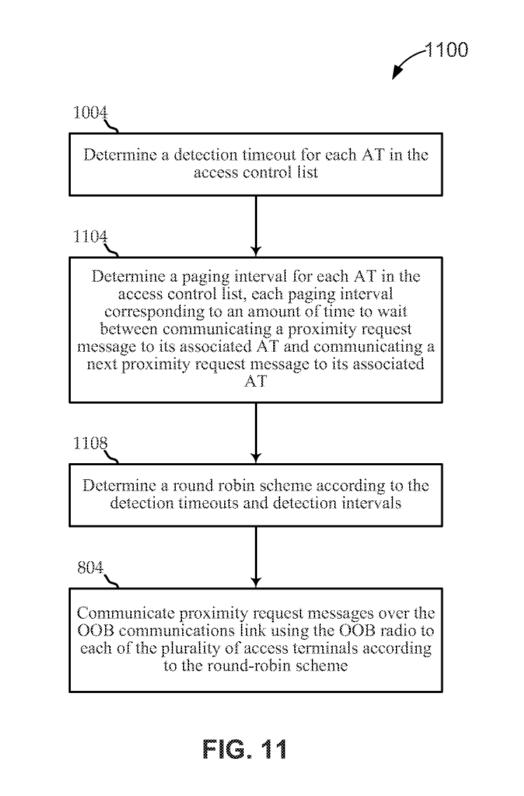

It will be appreciated that additional modifications to the round-robin scheme are possible. For example, the paging intervals can be adjusted (e.g., according to FIG. 9), the detection timeouts can be adjusted (e.g., according to FIGS. 10A-10C), and/or both the paging intervals and the detection timeouts can be adjusted concurrently. FIG. 11 shows a flow diagram of such an exemplary method 1100 for OOB proximity detection that includes determining and adjusting both the paging intervals and the detection timeouts for each AT 115.

The method 1100 begins at stage 1004 by determining a detection timeout for each AT 115 in the access control list (e.g., as discussed with reference to FIG. 10A-10C). As discussed above (e.g., with reference to FIGS. 7D and 7E), it may be desirable to spend substantially the same amount of time on average detecting each AT 115 in the ACL, even when certain ATs 115 are associated with a shorter detection timeout. Accordingly, those ATs 115 associated with a shorter detection timeout may also be associated with a shorter paging interval.

As show, at stage 1104, a paging interval is determined for each AT 115 in the access control list. Each paging interval corresponds to an amount of time to wait between communicating a proximity request message (e.g., or, more typically, a set of proximity messages, link one or more messaging trains) to its associated AT 115 and communicating a next proximity request message to its associated AT 115. By shortening the paging interval, the OOB 240 effectively spends more time on average detecting the associated AT 115, which can be configured to compensate for a reduction in detection timeout (e.g., for added fairness). At stage 1108, the round robin scheme is determined according to the detection timeouts and the paging intervals for the ATs 115. Having determined a round-robin scheme, proximity request messages are communicated over the OOB channel using the OOB radio to each of the plurality of access terminals according to the round-robin scheme, for example, according to stage 804 of FIG. 8.

The various operations of methods described above may be performed by any suitable means capable of performing the corresponding functions. The means may include various hardware and/or software component(s) and/or module(s), including, but not limited to a circuit, an application specific integrate circuit (ASIC), or processor.

The various illustrative logical blocks, modules, and circuits described may be implemented or performed with a general purpose processor, a digital signal processor (DSP), an ASIC, a field programmable gate array signal (FPGA), or other programmable logic device (PLD), discrete gate, or transistor logic, discrete hardware components, or any combination thereof designed to perform the functions described herein. A general purpose processor may be a microprocessor, but in the alternative, the processor may be any commercially available processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of tangible storage medium. Some examples of storage media that may be used include random access memory (RAM), read only memory (ROM), flash memory, EPROM memory, EEPROM memory, registers, a hard disk, a removable disk, a CD-ROM, and so forth. A storage medium may be coupled to a processor such that the processor can read information from, and write information to, the storage medium. In the alternative, the storage medium may be integral to the processor. A software module may be a single instruction, or many instructions, and may be distributed over several different code segments, among different programs, and across multiple storage media.

The methods disclosed herein comprise one or more actions for achieving the described method. The method and/or actions may be interchanged with one another without departing from the scope of the claims. In other words, unless a specific order of actions is specified, the order and/or use of specific actions may be modified without departing from the scope of the claims.

The functions described may be implemented in hardware, software, firmware, or any combination thereof If implemented in software, the functions may be stored as one or more instructions on a tangible computer-readable medium. A storage medium may be any available tangible medium that can be accessed by a computer. By way of example, and not limitation, such computer-readable media can comprise RAM, ROM, EEPROM, CD-ROM, or other optical disk storage, magnetic disk storage, or other magnetic storage devices, or any other tangible medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, a computer program product may perform operations presented herein. For example, such a computer program product may be a computer readable tangible medium having instructions tangibly stored (and/or encoded) thereon, the instructions being executable by one or more processors to perform the operations described herein. The computer program product may include packaging material.

Software or instructions may also be transmitted over a transmission medium. For example, software may be transmitted from a website, server, or other remote source using a transmission medium such as a coaxial cable, fiber optic cable, twisted pair, digital subscriber line (DSL), or wireless technology such as infrared, radio, or microwave.

Further, modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized.

Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C). Further, the term “exemplary” does not mean that the described example is preferred or better than other examples.

Various changes, substitutions, and alterations to the techniques described herein can be made without departing from the technology of the teachings as defined by the appended claims. Moreover, the scope of the disclosure and claims is not limited to the particular aspects of the process, machine, manufacture, composition of matter, means, methods, and actions described above. Processes, machines, manufacture, compositions of matter, means, methods, or actions, presently existing or later to be developed, that perform substantially the same function or achieve substantially the same result as the corresponding aspects described herein may be utilized. Accordingly, the appended claims include within their scope such processes, machines, manufacture, compositions of matter, means, methods, or actions.

What is claimed is:

1. A method for out-of-band paging in a femto deployment, the method comprising:
communicating proximity request messages over an OOB communications channel using an out-of-band (OOB) radio to each of a plurality of access terminals according to a round-robin scheme; and
receiving a proximity response message from at least one access terminal over the OOB communications channel using the OOB radio, the proximity response message indicating that the at least one access terminal is in proximity to a femtocell,
the femtocell being integrated with the OOB radio as part of a femto-proxy system and the plurality of access terminals being authorized to communicate via the femtocell according to an access control list associated with the femtocell.

2. The method of claim 1, further comprising:
communicating a proximity indication to a core network element to facilitate active hand-in of the at least one access terminal to the femtocell in response to receiving the proximity response message from the at least one access terminal.

3. The method of claim 2, wherein the proximity indication is communicated to the core network element only when the at least one access terminal is determined to be in a wireless wide-area network (WWAN) active communications mode.

4. The method of claim 1, wherein:
the plurality of access terminals comprises a first subset of access terminals in proximity to the femtocell and a second subset of access terminals not in proximity to the femtocell, the first subset of access terminals comprising the at least one access terminal; and
communicating the proximity request messages over the OOB communications channel using the OOB radio to each of the plurality of access terminals according to the round-robin scheme comprises:
communicating the proximity request messages over the OOB communications channel using the OOB radio to each of the first subset of access terminals according to a first time interval; and
communicating the proximity request messages over the OOB communications channel using the OOB radio to each of the second subset of access terminals according to a second time interval.

5. The method of claim 4, wherein the first time interval is longer than the second time interval.

6. The method of claim 1, further comprising:
determining the round-robin scheme at least partially according to detection timeouts associated with each of the plurality of access terminals, each detection timeout corresponding to an amount of time to wait for receipt of a proximity response message from its associated access terminal after communicating a corresponding proximity request message to its associated access terminal.

7. The method of claim 6, further comprising:
determining at least one detection timeout at least according to a non-dynamic characteristic of its associated access terminal.

8. The method of claim 6, further comprising:
detecting a non-dynamic characteristic of a designated access terminal from information received from the designated access terminal over the OOB communications channel;
retrieving a preset value from a data store corresponding to the non-dynamic characteristic of the designated access terminal; and
setting the detection timeout associated with the designated access terminal according to the preset value.

9. The method of claim 6, further comprising:
for a designated access terminal of the first subset of access terminals, monitoring an elapsed time between communicating a proximity request message to the designated access terminal and receiving a corresponding proximity response message from the designated access terminal; and
dynamically adjusting the detection timeout associated with the designated access terminal according to the monitored elapsed time.

10. The method of claim 6, further comprising:
determining the round-robin scheme further according to paging intervals associated with each of the plurality of access terminals, each paging interval corresponding to an amount of time to wait between communicating a proximity request message to its associated access terminal and communicating a next proximity request message to its associated access terminal.

11. The method of claim 10, further comprising:
determining each paging interval according to the detection timeout of its associated access terminal, such that longer paging intervals are associated with access terminals having longer detection timeouts.

12. The method of claim 10, further comprising:
determining each paging interval according to the detection timeout of its associated access terminal, such that each access terminal is associated with substantially a same average detection time, the average detection time over a duration for each access terminal being defined by dividing the duration by the paging interval of the access terminal to yield a result, and multiplying the result by the detection timeout of the access terminal.

13. The method of claim 1, wherein the OOB communications channel is an ad hoc communications channel.

14. The method of claim 1, wherein:
the OOB communications channel is a Bluetooth channel; and
the proximity request messages are Bluetooth paging messages.

15. The method of claim 1, further comprising:
identifying an attached access terminal as having an established OOB communications link over the OOB communications channel with the OOB radio;
communicating the proximity request messages to the attached access terminal over the OOB link without including the attached access terminal in the round-robin scheme; and
receiving the proximity response message from the attached access terminal over the OOB communications link.

16. The method of claim 15, wherein:
the OOB communications link is a Bluetooth link; and
the proximity request messages are Bluetooth polling messages.

17. A femto-proxy system comprising:
a femtocell, configured to provide macro network access to a plurality of access terminals authorized to attach to the femtocell according to an access control list; and
an out-of-band (OOB) radio, integrated with the femtocell and configured to:
communicate a proximity request message over an OOB communications channel to each of the plurality of access terminals according to a round-robin scheme; and
receive a proximity response message over the OOB communications channel from at least one access terminal, the proximity response message indicating that the at least one access terminal is in proximity to the femtocell.

18. The femto-proxy system of claim 17, wherein:
the femtocell is further configured to communicate a proximity indication to a core network element to facilitate active hand-in of the at least one access terminal to the femtocell in response to receiving the proximity response message from the at least one access terminal.

19. The femto-proxy system of claim 17, wherein:
the plurality of access terminals comprises a first subset of access terminals in proximity to the femtocell and a second subset of access terminals not in proximity to the femtocell, the first subset of access terminals comprising the at least one access terminal; and
the OOB radio is configured to communicate the proximity request messages over the OOB communications channel to each of the plurality of access terminals according to the round-robin scheme by:
communicating the proximity request message to each of the first subset of access terminals according to a first time interval; and
communicating the proximity request messages to each of the second subset of access terminals according to a second time interval,
wherein the first time interval is longer than the second time interval.

20. The femto-proxy system of claim 17, further comprising:
determining the round-robin scheme at least partially according to detection timeouts associated with each of the plurality of access terminals, each detection timeout corresponding to an amount of time to wait for receipt of a proximity response message from its associated access terminal after communicating a corresponding proximity request message to its associated access terminal.

21. The femto-proxy system of claim 20, further comprising:
determining at least one detection timeout at least according to a non-dynamic characteristic of its associated access terminal.

22. The femto-proxy system of claim 20, further comprising:
for a designated access terminal of the first subset of access terminals, monitoring an elapsed time between communicating a proximity request message to the designated access terminal and receiving a corresponding proximity response message from the designated access terminal; and
dynamically adjusting the detection timeout associated with the designated access terminal according to the monitored elapsed time.

23. The femto-proxy system of claim 20, further comprising:
determining the round-robin scheme further according to paging intervals associated with each of the plurality of access terminals, each paging interval corresponding to an amount of time to wait between communicating a proximity request message to its associated access terminal and communicating a next proximity request message to its associated access terminal.

24. The femto-proxy system of claim 23, further comprising:
determining each paging interval according to the detection timeout of its associated access terminal, such that longer paging intervals are associated with access terminals having longer detection timeouts.

25. The femto-proxy system of claim 23, further comprising:
determining each paging interval according to the detection timeout of its associated access terminal, such that each access terminal is associated with substantially a same average detection time, the average detection time over a duration for each access terminal being defined by dividing the duration by the paging interval of the access terminal to yield a result, and multiplying the result by the detection timeout of the access terminal.

26. The femto-proxy system of claim 17, wherein the OOB radio is configured to:
detect an attached access terminal separate from the plurality of access terminals that is in proximity to the femtocell and has an established OOB communications link over the OOB channel with the OOB radio;
communicate the proximity request messages over the OOB communications link to each of the set of access terminals without including the attached access terminal in the round-robin scheme; and
receive response messages over the OOB communications link from each of the set of access terminals.

27. A processor comprising:
a femto controller configured to direct a femtocell to provide macro network access to a plurality of access terminals authorized to attach to the femtocell according to an access control list; and
an out-of-band (OOB) controller configured to direct an OOB radio to:
communicate a proximity request message over an OOB communications channel to each of the plurality of access terminals according to a round-robin scheme; and
receive a proximity response message over the OOB communications channel from at least one access terminal, the proximity response message indicating that the at least one access terminal is in proximity to the femtocell.

28. The processor of claim 27, wherein:
the femto controller is further configured to communicate a proximity indication to a core network element to facilitate active hand-in of the at least one access terminal to the femtocell in response to receiving the proximity response message from the at least one access terminal.

29. The processor of claim 27, wherein:
the plurality of access terminals comprises a first subset of access terminals in proximity to the femtocell and a second subset of access terminals not in proximity to the femtocell, the first subset of access terminals comprising the at least one access terminal; and
the OOB controller is configured to direct the OOB radio to communicate the proximity request messages over the OOB communications channel to each of the plurality of access terminals according to the round-robin scheme by:
communicating the proximity request message to each of the first subset of access terminals according to a first time interval; and
communicating the proximity request messages to each of the second subset of access terminals according to a second time interval,
wherein the first time interval is longer than the second time interval.

30. The processor of claim 27, further comprising:
determining the round-robin scheme at least partially according to detection timeouts associated with each of the plurality of access terminals, each detection timeout corresponding to an amount of time to wait for receipt of a proximity response message from its associated access terminal after communicating a corresponding proximity request message to its associated access terminal.

31. The processor of claim 30, further comprising:
determining at least one detection timeout at least according to a non-dynamic characteristic of its associated access terminal.

32. The processor of claim 30, further comprising:
for a designated access terminal of the first subset of access terminals, monitoring an elapsed time between communicating a proximity request message to the designated access terminal and receiving a corresponding proximity response message from the designated access terminal; and
dynamically adjusting the detection timeout associated with the designated access terminal according to the monitored elapsed time.

33. The processor of claim 30, further comprising:
determining the round-robin scheme further according to paging intervals associated with each of the plurality of access terminals, each paging interval corresponding to an amount of time to wait between communicating a proximity request message to its associated access terminal and communicating a next proximity request message to its associated access terminal.

34. The processor of claim 33, further comprising:
determining each paging interval according to the detection timeout of its associated access terminal, such that longer paging intervals are associated with access terminals having longer detection timeouts.

35. The processor of claim 33, further comprising:
determining each paging interval according to the detection timeout of its associated access terminal, such that each access terminal is associated with substantially a same average detection time, the average detection time over a duration for each access terminal being defined by dividing the duration by the paging interval of the access terminal to yield a result, and multiplying the result by the detection timeout of the access terminal.

36. The processor of claim 27, wherein the OOB controller is further configured to direct the OOB radio to:
detect an attached access terminal separate from the plurality of access terminals that is in proximity to the femtocell and has an established OOB communications link over the OOB channel with the OOB radio;
communicate the proximity request messages over the OOB communications link to the attached access terminal without including the attached access terminal in the round-robin scheme; and
receive response messages over the OOB communications link from each of the set of access terminals.

37. A computer program product residing on a non-transitory, processor-readable medium and comprising processor-readable instructions, which, when executed, cause a processor to perform steps comprising:
communicating proximity request messages over an OOB communications channel using an out-of-band (OOB) radio to each of a plurality of access terminals according to a round-robin scheme; and
receiving a proximity response message from at least one access terminal over the OOB communications channel using the OOB radio, the proximity response message indicating that the at least one access terminal is in proximity to a femtocell,
the femtocell being integrated with the OOB radio as part of a femto-proxy system and the plurality of access terminals being authorized to communicate via the femtocell according to an access control list associated with the femtocell.

38. The computer program product of claim 37, the processor-readable instructions, when executed, causing the processor to perform steps further comprising:
communicating a proximity indication to a core network element to facilitate active hand-in of the at least one access terminal to the femtocell in response to receiving the proximity response message from the at least one access terminal.

39. The computer program product of claim 37, wherein:
the plurality of access terminals comprises a first subset of access terminals in proximity to the femtocell and a second subset of access terminals not in proximity to the femtocell, the first subset of access terminals comprising the at least one access terminal; and
the processor-readable instructions, when executed, cause the processor to communicate the proximity request messages over the OOB communications channel using the OOB radio to each of the plurality of access terminals according to the round-robin scheme by:
communicating the proximity request messages over the OOB communications channel using the OOB radio to each of the first subset of access terminals according to a first time interval; and
communicating the proximity request messages over the OOB communications channel using the OOB radio to each of the second subset of access terminals according to a second time interval,
the first time interval being longer than the second time interval.

40. The computer program product of claim 37, the processor-readable instructions, when executed, causing the processor to perform steps further comprising:
determining the round-robin scheme at least partially according to detection timeouts associated with each of the plurality of access terminals, each detection timeout corresponding to an amount of time to wait for receipt of a proximity response message from its associated access terminal after communicating a corresponding proximity request message to its associated access terminal.

41. The computer program product of claim 40, the processor-readable instructions, when executed, causing the processor to perform steps further comprising:
determining at least one detection timeout at least according to a non-dynamic characteristic of its associated access terminal.

42. The computer program product of claim 40, the processor-readable instructions, when executed, causing the processor to perform steps further comprising:
for a designated access terminal of the first subset of access terminals, monitoring an elapsed time between communicating a proximity request message to the designated access terminal and receiving a corresponding proximity response message from the designated access terminal; and
dynamically adjusting the detection timeout associated with the designated access terminal according to the monitored elapsed time.

43. The computer program product of claim 40, the processor-readable instructions, when executed, causing the processor to perform steps further comprising:
determining the round-robin scheme further according to paging intervals associated with each of the plurality of access terminals, each paging interval corresponding to an amount of time to wait between communicating a proximity request message to its associated access terminal and communicating a next proximity request message to its associated access terminal.

44. The computer program product of claim 43, the processor-readable instructions, when executed, causing the processor to perform steps further comprising:
determining each paging interval according to the detection timeout of its associated access terminal, such that longer paging intervals are associated with access terminals having longer detection timeouts.

45. The computer program product of claim 43, the processor-readable instructions, when executed, causing the processor to perform steps further comprising:
determining each paging interval according to the detection timeout of its associated access terminal, such that each access terminal is associated with substantially a same average detection time, the average detection time over a duration for each access terminal being defined by dividing the duration by the paging interval of the access terminal to yield a result, and multiplying the result by the detection timeout of the access terminal.

46. The computer program product of claim 37, the processor-readable instructions, when executed, causing the processor to perform steps further comprising:
identifying an attached access terminal as having an established OOB communications link over the OOB communications channel with the OOB radio;
communicating the proximity request messages to the attached access terminal over the OOB link without including the attached access terminal in the round-robin scheme; and
receiving the proximity response message from the attached access terminal over the OOB communications link.

47. A system comprising:
means for communicating proximity request messages over an OOB communications channel using an out-of-band (OOB) radio to each of a plurality of access terminals according to a round-robin scheme; and
means for receiving a proximity response message from at least one access terminal over the OOB communications channel using the OOB radio, the proximity response message indicating that the at least one access terminal is in proximity to a femtocell,
the femtocell being integrated with the OOB radio as part of a femto-proxy system and the plurality of access terminals being authorized to communicate via the femtocell according to an access control list associated with the femtocell.

48. The system of claim 47, further comprising:
means for communicating a proximity indication to a core network element to facilitate active hand-in of the at least one access terminal to the femtocell in response to receiving the proximity response message from the at least one access terminal.

49. The system of claim 47, wherein:
the plurality of access terminals comprises a first subset of access terminals in proximity to the femtocell and a second subset of access terminals not in proximity to the femtocell, the first subset of access terminals comprising the at least one access terminal; and
the means for communicating the proximity request message comprises:
means for communicating the proximity request message to each of the first subset of access terminals according to a first time interval; and
means for communicating the proximity request messages to each of the second subset of access terminals according to a second time interval,
the first time interval being longer than the second time interval.

50. The system of claim 47, further comprising:
means for determining the round-robin scheme at least partially according to detection timeouts associated with each of the plurality of access terminals, each detection timeout corresponding to an amount of time to wait for receipt of a proximity response message from its associated access terminal after communicating a corresponding proximity request message to its associated access terminal.

51. The system of claim 50, further comprising:
means for determining at least one detection timeout at least according to a non-dynamic characteristic of its associated access terminal.

52. The system of claim 50, further comprising:
means for monitoring, for a designated access terminal of the first subset of access terminals, an elapsed time between communicating a proximity request message to the designated access terminal and receiving a corresponding proximity response message from the designated access terminal; and
means for dynamically adjusting the detection timeout associated with the designated access terminal according to the monitored elapsed time.

53. The system of claim 50, further comprising:
means for determining the round-robin scheme further according to paging intervals associated with each of the plurality of access terminals, each paging interval corresponding to an amount of time to wait between communicating a proximity request message to its associated access terminal and communicating a next proximity request message to its associated access terminal.

54. The system of claim 53, further comprising:
means for determining each paging interval according to the detection timeout of its associated access terminal, such that longer paging intervals are associated with access terminals having longer detection timeouts.

55. The system of claim 53, further comprising:
means for determining each paging interval according to the detection timeout of its associated access terminal, such that each access terminal is associated with substantially a same average detection time, the average detection time over a duration for each access terminal being defined by dividing the duration by the paging interval of the access terminal to yield a result, and multiplying the result by the detection timeout of the access terminal.

56. The system of claim 47, further comprising:
means for identifying an attached access terminal as having an established OOB communications link over the OOB communications channel with the OOB radio;
means for communicating the proximity request messages to the attached access terminal over the OOB link without including the attached access terminal in the round-robin scheme; and
means for receiving the proximity response message from the attached access terminal over the OOB communications link.
